(19) United States
(12) Patent Application Publication
(10) Pub. No.: US 2025/0376112 A1
(43) Pub. Date: Dec. 11, 2025

(54) HAPTIC INPUT/OUTPUT DEVICE FOR RECREATIONAL VEHICLES

(71) Applicant: Polaris Industries Inc., Medina, MN (US)

(72) Inventors: Tyler A. Alexander, Battle Ground, WA (US); Dylan A. Clark, Circle Pines, MN (US); Jack Damiano, St. Paul, MN (US); Brian D. Krosschell, North Branch, MN (US); Mark A. Powell, Camas, WA (US); Aidan B. Shaughnessy, Overland Park, KS (US); Scott D. Taylor, Blaine, MN (US); Carl A. Turner, Portland, OR (US)

(73) Assignee: Polaris Industries Inc., Medina, MN (US)

(21) Appl. No.: 19/202,732

(22) Filed: May 8, 2025

Related U.S. Application Data
(60) Provisional application No. 63/644,240, filed on May 8, 2024.

(51) Int. Cl. B60Q 9/00; B60R 16/00; B60R 16/023; G06F 3/01; G06F 3/0362

(52) U.S. Cl. CPC B60Q 9/00; B60R 16/005; B60R 16/0231; G06F 3/016; G06F 3/0362

(57) ABSTRACT

The present disclosure relates to a haptic input/output device for recreational vehicles. The disclosed aspects provide dynamic haptic feedback to a vehicle operator depending on a vehicle context and/or the functionality being controlled by the haptic input/output device. In some instances, the haptic input/output device is usable to control a touch-sensitive input device, thereby offering tactile feedback to a vehicle operator when controlling providing input via the touch-sensitive input device accordingly.

### RELATED APPLICATION

Applicant claims the benefit of and priority to U.S. Provisional Application No. 63/644,240, filed May 8, 2024, the disclosure of which is incorporated herein by reference in its entirety.

### BACKGROUND

An operator interface of a recreational vehicle may include one or more input and output devices to facilitate user interaction and control over vehicle systems. Input devices can include switches, touchscreens, and other devices configured to receive commands or data. Output devices can include displays, speakers, lights, and other devices configured to convey information or perform operations in response to inputs.

### SUMMARY

Some aspects of the disclosure are directed to a method, comprising: determining a current function for a haptic input/output (I/O) device to provide functionality for control of a recreational vehicle; determining a profile associated with the current function, wherein the profile defines haptic feedback comprising any one of: (i) one or more detents, (ii) one or more end stops, (iii) one or more return-to-position forces, or (iv) any combination of (i)-(iii); and causing the haptic I/O device to operate according to the profile to provide the haptic feedback and control the recreational vehicle. In certain examples, causing the haptic I/O device to operate according to the profile comprises: detecting actuation of a knob of the haptic I/O device; operating a mechanical actuator of the haptic I/O device to provide the haptic feedback; and providing an indication of the actuation to the recreational vehicle to control the recreational vehicle. In example implementations, providing the indication of the actuation to the recreational vehicle comprises providing the indication of the actuation to a vehicle controller of the recreational vehicle.

In some examples, the current function is a shifter for selecting a transmission gear of the recreational vehicle; and the profile defines a plurality of set positions for selecting each transmission gear option. In example implementations, the haptic feedback comprises biasing a knob of the haptic I/O device to settle at one of the plurality of set positions. In certain examples, the method further comprises detecting actuation of a knob of the haptic I/O device indicating a transmission gear option selection based on the knob settling at one of the plurality of set positions; operating a mechanical actuator of the haptic I/O device to provide the haptic feedback; and providing an indication of the actuation to the recreational vehicle to control the recreational vehicle, including setting a transmission of the recreational vehicle to the transmission gear option selection.

In certain examples, the current function is any one of: (i) a shifter, (ii) a drive mode selector, (iii) a drive gear selector, (iv) a winch controller, (v) a light controller, (vi) a navigation controller, (vii) an audio system controller, (viii) a suspension tuner, (ix) an operator interface controller, (x) an agricultural system controller, (xi) a recreational vehicle bed controller, (xii) a haptic I/O input knob mode selector, (xiii) a vehicle tracker, (xiv) a terrain traversal controller, or (xv) a plow controller. In examples, the profile further defines the haptic feedback as comprising active feedback. In some examples, the method further comprises determining the haptic I/O device has not been actuated for a period; determining a standby profile of a standby function; and causing the haptic I/O device to operate according to the standby profile.

In certain examples, the method further comprises determining a speed of the recreational vehicle is above a speed threshold; determining a high-speed profile of a high-speed function; and causing the haptic I/O device to operate according to the high-speed profile. In some examples, the method further comprises determining an accessory is connected to the vehicle; determining an accessory profile associated with an accessory function to control the accessory; determining the current function is the accessory function; and causing the haptic I/O device to operate according to the accessory profile to control the accessory.

Some aspects of the disclosure are directed to a haptic input/output (I/O) device for a recreational vehicle, the haptic I/O device comprising: a knob configured to receive input and provide output via rotation; a position sensor configured to identify a rotational position of the knob; a mechanical actuator configured to actuate the knob; and an I/O device controller, configured to: determine a current function for the haptic I/O device to provide functionality for control of the recreational vehicle; determine a profile associated with the current function, wherein the profile defines haptic feedback comprising any one of: (i) one or more detents, (ii) one or more end stops, (iii) one or more return-to-position forces, or (iv) any combination of (i)-(iii); and cause the haptic I/O device to operate according to the profile to provide the haptic feedback and control the recreational vehicle. In some examples, to cause the haptic I/O device to operate according to the profile comprises the I/O device controller to: detect, using the position sensor, actuation of the knob; operate the mechanical actuator according to an operating mode to provide the haptic feedback; and provide an indication of the detected actuation to the recreational vehicle to control the recreational vehicle. In certain examples, to provide the indication of the actuation to the recreational vehicle comprises to provide the indication of the actuation to a vehicle controller of the recreational vehicle.

In certain examples, the current function is a shifter for selecting a transmission gear of the recreational vehicle; and the profile defines a plurality of set positions for selecting each transmission gear option. In example implementations, the haptic feedback comprises the mechanical actuator biasing the knob of the haptic I/O device to settle at one of the plurality of set positions. In some examples, the I/O device controller is further configured to: detect, using the position sensor, actuation of the knob indicating a transmission gear option selection based on the knob settling at one of the plurality of set positions; operate the mechanical actuator to provide the haptic feedback; and provide an indication of the actuation to the recreational vehicle to control the recreational vehicle, including setting a transmission of the recreational vehicle to the transmission gear option selection.

In certain examples, the profile further defines the haptic feedback as comprising active feedback. In some examples, the I/O device controller is further configured to: determine the haptic I/O device has not been actuated for a period; determine a standby profile of a standby function; and cause the haptic I/O device to operate according to the standby profile. In some examples, the I/O device controller is further configured to: determine a speed of the recreational vehicle is above a speed threshold; determine a high-speed profile of a high-speed function; and cause the haptic I/O device to operate according to the high-speed profile. In examples, the I/O device controller is further configured to: determine an accessory is connected to the vehicle; determine an accessory profile associated with an accessory function to control the accessory; determine the current function is the accessory function; and cause the haptic I/O device to operate according to the accessory profile to control the accessory.

In certain examples, the I/O device controller is further configured to: receive information associated with the recreational vehicle from a vehicle controller of the recreational vehicle; and operate the mechanical actuator to provide an indication of the received information. In examples, the haptic I/O device further comprises a magnet; the position sensor is a magnetic encoder configured to detect rotation of the magnet; and the mechanical actuator is a brushless direct current motor. In certain examples, the haptic I/O device further comprises a directional light system configured to provide output according to the profile.

In some examples, the haptic I/O device further comprises an enclosure with one or more environmental seals configured to provide ingress protection for the position sensor and the mechanical actuator. In certain examples, the haptic I/O device further comprises a tactile dome positioned to be depressed by the knob when the knob receives axial force.

Some aspects of the disclosure are directed to a vehicle, comprising: a vehicle controller; and a haptic I/O device comprising: a knob configured to receive input and provide output via rotation; a position sensor configured to identify a rotational position of the knob; a mechanical actuator configured to actuate the knob; and an I/O device controller, configured to: determine a current function for a haptic input/output (I/O) device to provide functionality for control of a recreational vehicle; determine a profile associated with the current function, wherein the profile defines haptic feedback comprising any one of: (i) one or more detents, (ii) one or more end stops, (iii) one or more return-to-position forces, or (iv) any combination of (i)-(iii); and cause the haptic I/O device to operate according to the profile to provide the haptic feedback and control the recreational vehicle.

### BRIEF DESCRIPTION OF THE DRAWINGS

The following drawings are illustrative of particular examples of the present disclosure and therefore do not limit the scope of the present disclosure. The drawings are not to scale and are intended for use in conjunction with the explanations in the following detailed description. Examples of the present disclosure will hereinafter be described in conjunction with the appended drawings, wherein like numerals denote like elements.

FIG. 1A illustrates an example of a haptic input/output (I/O) device and a vehicle display on an example of a vehicle in accordance with aspects of the present disclosure.

FIG. 1B illustrates another example of a haptic I/O device and a vehicle display on the example of the vehicle illustrated in FIG. 1A.

FIG. 1C illustrates another example of a haptic I/O device, a vehicle display, and a second display on the vehicle illustrated in FIG. 1A.

FIG. 1D illustrates another example of a haptic I/O device, a vehicle display, and a second display on the vehicle illustrated in FIG. 1A.

FIG. 1E illustrates an example of a haptic I/O device and a vehicle on another example of a vehicle in accordance with aspects of the present disclosure.

FIG. 1F illustrates another example of a haptic I/O device and a vehicle display on the example of the vehicle illustrated in FIG. 1E.

FIG. 2 is a representative view of an example vehicle in accordance with aspects of the present disclosure.

FIG. 3A illustrates an example haptic I/O device in accordance with aspects of the present disclosure.

FIG. 3B is a partially exploded perspective view of the haptic I/O device in accordance with aspects of the present disclosure.

FIG. 3C is an exploded perspective view of the haptic I/O device in accordance with aspects of the present disclosure.

FIG. 3D is a cross-sectional view of the haptic I/O device in accordance with aspects of the present disclosure.

FIG. 3E is a view of the haptic I/O device illustrating the printed circuit board in accordance with aspects of the present disclosure.

FIG. 4A illustrates directional lighting of the haptic I/O device in accordance with aspects of the present disclosure.

FIG. 4B illustrates directional lighting of the haptic I/O device for positional indication of a second vehicle in accordance with aspects of the present disclosure.

FIG. 5A illustrates a haptic I/O device shifter user interface (UI) in accordance with aspects of the present disclosure.

FIG. 5B illustrates a haptic I/O device rock crawl UI in accordance with aspects of the present disclosure.

FIG. 5C illustrates a haptic I/O device winch UI in accordance with aspects of the present disclosure.

FIG. 5D illustrates a haptic I/O device function selection UI in accordance with aspects of the present disclosure.

FIG. 6 illustrates a device configured to receive input from various input devices in accordance with aspects of the present disclosure.

FIG. 7 is a diagram of a process for controlling input and output functionality of the haptic I/O device in accordance with aspects of the present disclosure.

FIG. 8 is a diagram of a process for enabling the haptic I/O device to control functionality of an accessory in accordance with aspects of the present disclosure.

FIG. 9 is a diagram of a process for managing the functionality of the haptic I/O device based on a speed of the recreational vehicle in accordance with aspects of the present disclosure.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Examples may be practiced as processes (e.g., methods), systems, or devices. The following detailed description is therefore not to be taken in a limiting sense, and the scope of the present disclosure is defined by the appended claims and their equivalents.

An operator interface of a recreational vehicle may include one or more input and/or output devices. However, due to the variety of contexts in which the recreational vehicle can be used (e.g., varying terrain, weather, and/or seasons), a device that is well-suited for a first context may be less suitable for a second context. For instance, vibration introduced by certain terrain may make it difficult for an operator (e.g., user) to operate a touch screen, gloves worn by the operator in certain conditions may make it difficult for the operator to feel haptic feedback, and so on. Different functions of the recreational vehicle and installed accessories can also benefit from different types of input and/or output devices.

The haptic input/output (I/O) device described herein can receive input for multiple functions and provide variable feedback based on the present function and context of the recreational vehicle. For example, the haptic I/O device can include a rotatable knob configured to receive input via rotational movement and/or depression of the knob. The haptic I/O device can utilize a motor to provide configurable feedback via controlled motor actuation. For different functions, the I/O device can provide customized feedback via the motor actuation including detents with variable strength, frequency, and position, rotational resistance, end stops, return-to-position force, force feedback, and/or the like. The haptic I/O device can include a display, such as on the face of the rotatable knob, for displaying information and/or receiving input via touch. The haptic I/O device can also include a lighting system, such as a directional lighting system, for outputting information. The haptic I/O device can obviate or otherwise reduce the need for additional input and/or output devices in a recreational vehicle and can adjust input and output functionality based on the current function and recreational vehicle context to provide usable input and output capabilities.

Additionally, an input device of the recreational vehicle, such as a touchscreen or capacitive panel, can be configured to detect input from operators and/or various tactile input devices. Different types of input devices are better suited for particular applications. For example, a slider input device may be better suited for continuous, analog adjustments such as light brightness control and temperature setpoints, a switch or button may be better suited for binary adjustments such as turning components and accessories on and off and controlling pumps, knobs for analog control such as volume and temperature control, and/or the like. The input device can be configured to identify different input devices and inputs received from the input devices to enable an operator to configure the control of the recreational vehicle.

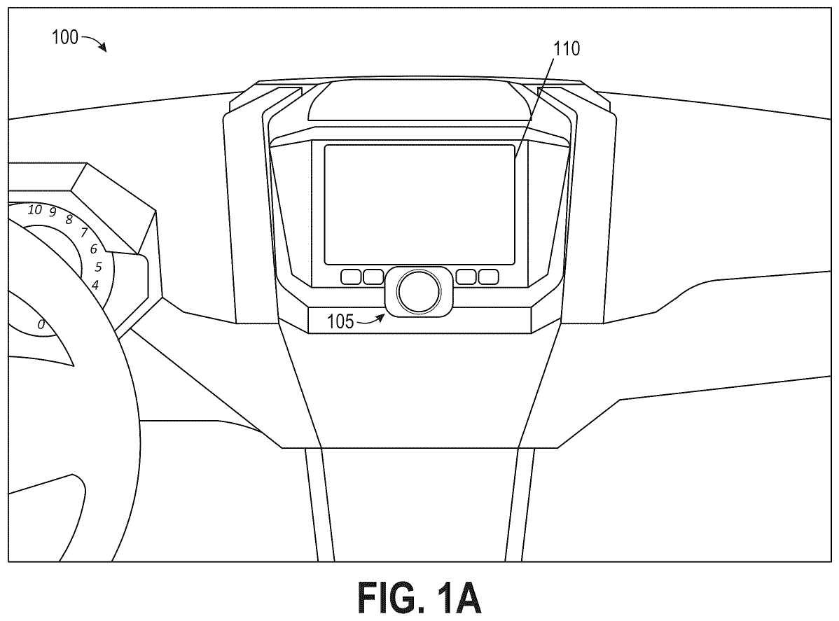

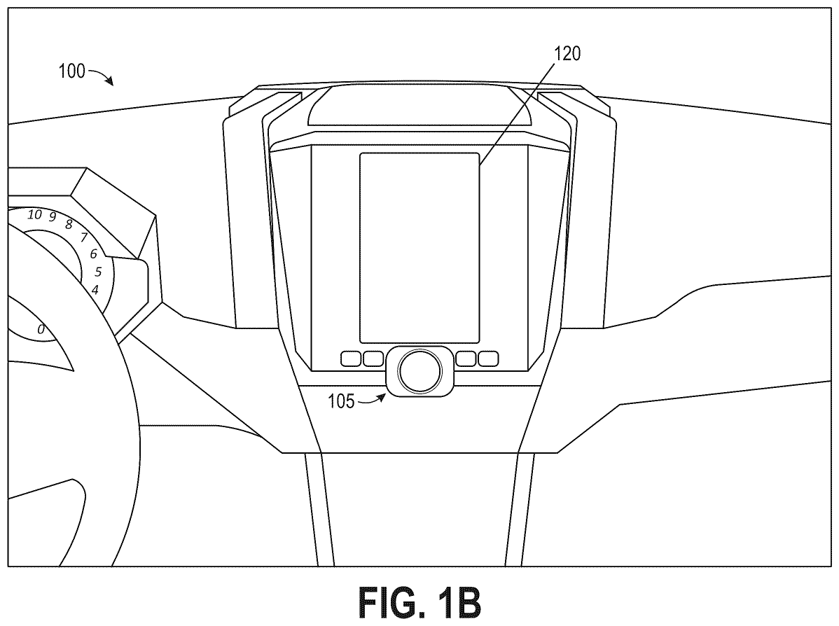

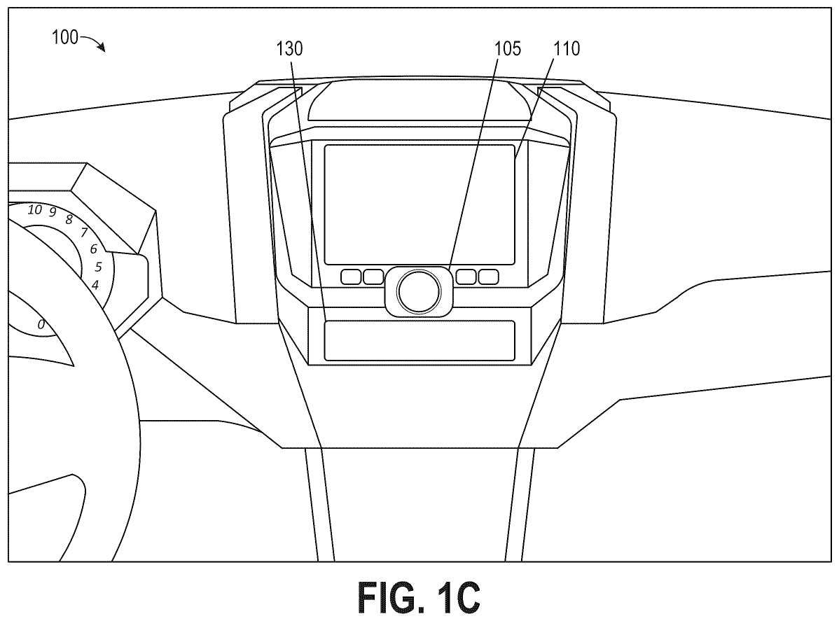

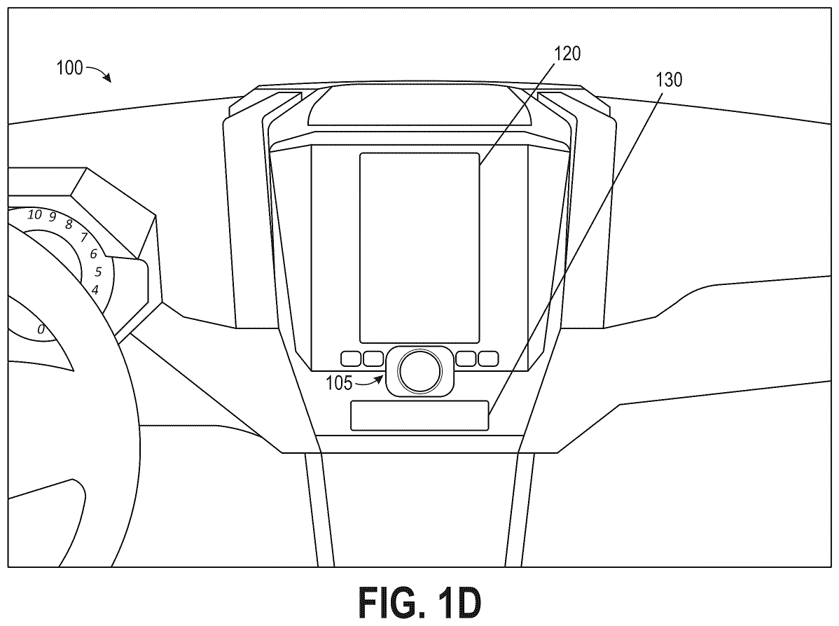

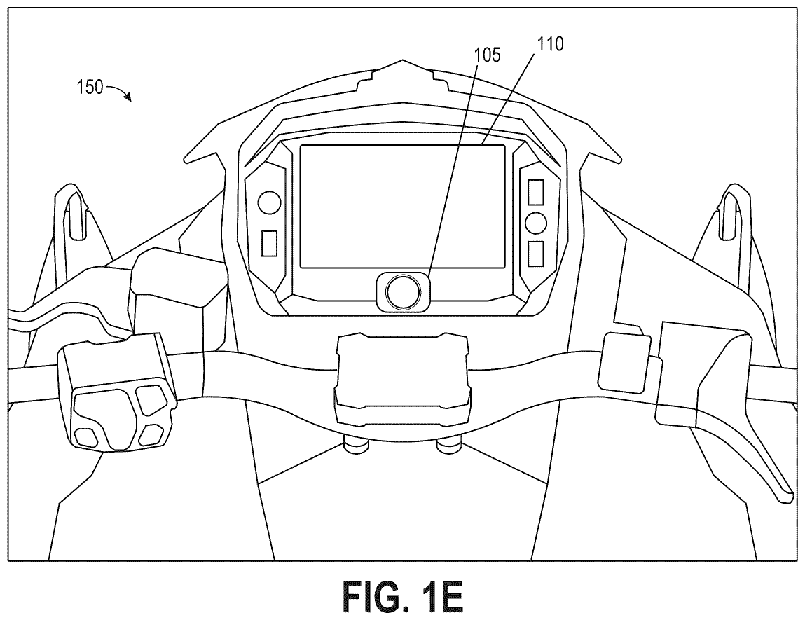

Turning now to FIGS. 1A-1F, example vehicle displays and I/O devices are shown. The illustrated examples show multiple configurations of vehicle displays and I/O devices on multiple types of vehicles. While these examples show configurations of vehicle displays on powersports vehicles, the scope of the present disclosure is not limited thereto. In some examples, other configurations of vehicle displays and I/O devices in other types of vehicle, including on-road vehicles, off-road vehicles, aquatic vehicles (e.g., boats and personal watercrafts), or other recreational vehicles, may be configured to present application interfaces and I/O devices with variable sizes, orientations, configurations, and so on. In examples, the vehicle displays and I/O devices may be part of an in-vehicle infotainment (IVI) system or otherwise communicate with the IVI system.

### Example Haptic I/O Device and Display Configurations in Vehicles

FIG. 1A illustrates a haptic I/O device 105 and a landscape-oriented display 110 in a first vehicle 100. For example, the first vehicle 100 may be a car, a utility task vehicle (UTV), or a similar off-road vehicle. The haptic I/O device 105 includes a rotatable knob that can receive input via rotational movement and/or depression of the knob. The haptic I/O device 105 can include a display, such as on the face of the rotatable knob, for displaying information and/or receiving input via touch. The haptic I/O device 105 can also include a lighting system (e.g., a directional lighting system) for outputting information. The haptic I/O device 105 can dynamically adjust haptic feedback capabilities for various functions. The haptic I/O device 105 will be described in further detail herein. The landscape-oriented display 110 may be a touchscreen or other I/O device for receiving input in example implementations. For ease of illustration, the first vehicle 100 is shown with the haptic I/O device 105 and the landscape-oriented display 110, but additional components may also be included in the first vehicle 100.

FIG. 1B illustrates another example of the first vehicle 100. In the example shown in FIG. 1B, the first vehicle 100 includes the haptic I/O device 105 and a portrait-oriented display 120. The portrait-oriented display 120 may be a touchscreen or other I/O device for receiving input in example implementations. Like with the example shown in FIG. 1A, the first vehicle 100 may include additional components that are not shown for ease of illustration.

FIG. 1C illustrates a further example of the first vehicle 100. In the example shown in FIG. 1C, the first vehicle 100 includes the haptic I/O device 105, the landscape-oriented display 110, and a second display 130. The second display 130 can be an input device, such as a touchscreen or capacitive panel, configured to detect input from operators and/or various tactile input devices. The second display 130 and associated input devices will be described in further detail herein. Like with example shown in FIG. 1A, the first vehicle 100 may include additional components that are not shown for ease of illustration.

FIG. 1D illustrates another example of the first vehicle 100. In the example shown in FIG. 1D, the first vehicle 100 includes the haptic I/O device 105, the portrait-oriented display 120, and the second display 130. Like with example shown in FIG. 1B, the first vehicle 100 may include additional components that are not shown for ease of illustration.

FIGS. 1E-F illustrate example of a second vehicle 150 with possible configurations of vehicle displays. In examples, the second vehicle 150 may be a straddled vehicle, such as a snowmobile, an all-terrain vehicle (ATV), a motorcycle, a dirt bike, or a personal watercraft. Like with the first vehicle 100 shown in FIGS. 1A-D, the second vehicle 150 may have a haptic I/O device 105, a landscape-oriented display 110 (shown in FIG. 1E) or a portrait-oriented display 120 (shown in FIG. 1F). The second vehicle 150 can also include the second display 130 in certain examples. Other configurations of I/O devices and vehicle displays may be possible as well.

In examples, any size I/O device and/or display may be used on either the first vehicle 100 and the second vehicle 150. For example, the haptic I/O device 105 can be sized based on the type of vehicle, available space, size of the displays, whether the haptic I/O device 105 includes a display, and so on. In examples, the landscape-oriented display 110 may be a 7-inch, 10.25-inch, or 12.3-inch display. In examples, the portrait-oriented display 120 may be a 7-inch or 10.4-inch display. Similarly, the vehicle displays and/or haptic I/O device 105 display may include any type of screen or digital vehicle gauge, including LCD screens, LED screens, and OLED screens.

In the illustrated examples, the vehicle displays 110, 120 are included on powersports vehicles 100, 150. Operation of powersports vehicles may require a high level of user attention and require increasing levels and/or various types of feedback for the operator to effectively identify the feedback. As such, interaction with the vehicle displays 110, 120 and/or I/O devices that cannot provide appropriate feedback may be difficult. Accordingly, by adjusting the haptic feedback provided by the haptic I/O device 105, interactions with the vehicle displays 110, 120 and/or other I/O devices can be reduced, improving response and control for the operator.

### Example Vehicle Systems

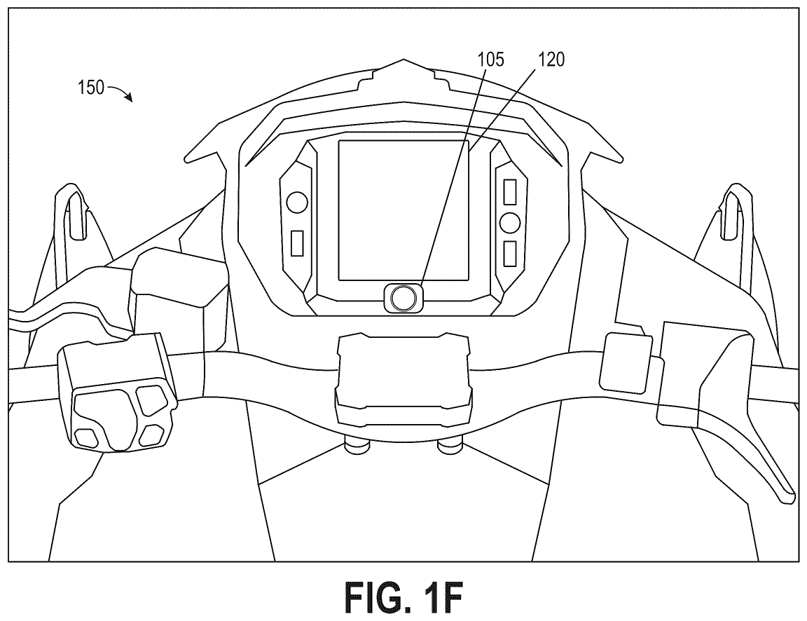

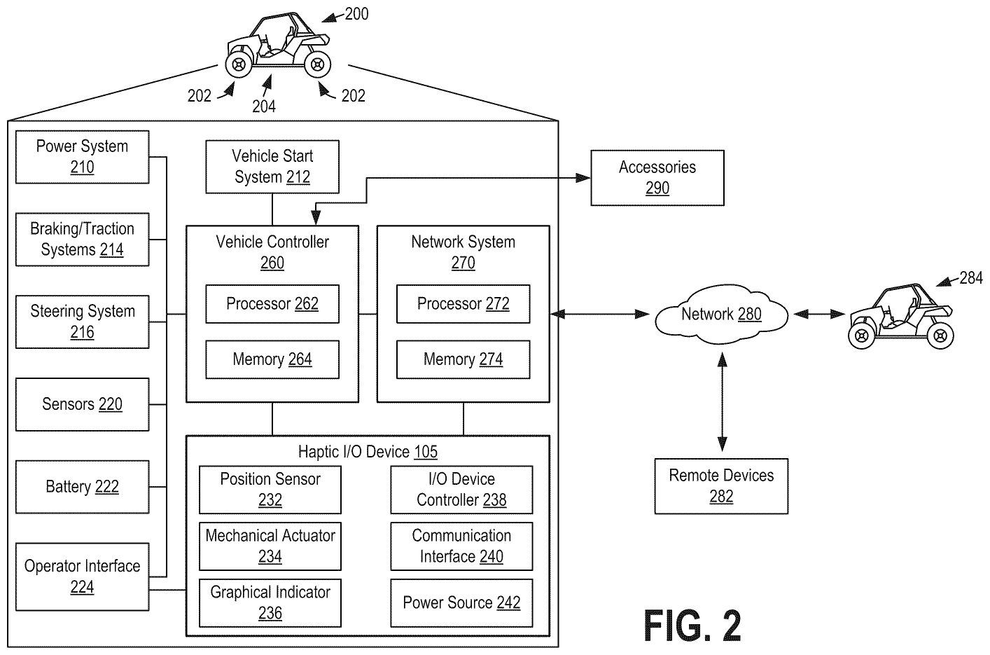

FIG. 2 is a representative view of an example vehicle 200 according to aspects described herein. In examples, the vehicle 200 may be an electric vehicle, an internal combustion vehicle, or a hybrid vehicle (e.g., having both an internal combustion engine and a traction motor), among other examples. In certain examples, the vehicle 200 is the first vehicle 100 or the second vehicle 150 illustrated in FIGS. 1A-1F.

The vehicle 200 includes a plurality of ground engaging members 202. Examples of ground engaging members include skis, endless tracks, wheels, and other suitable devices which support the vehicle 200 relative to the ground. The vehicle 200 further includes a frame 204 supported by the plurality of ground engaging members 202. In one example, the frame 204 includes cast portions, weldments, tubular components or a combination thereof. In one example, the frame 204 is a rigid frame. In an example, the frame 204 has at least two sections which are moveable relative to each other.

An operator support is supported by the frame 204. In addition to the operator support, the vehicle 200 may further include a passenger support. Example operator supports and passenger supports include straddle seats, bench seats, bucket seats, and other suitable support members.

A power system 210 is supported by the frame 204. The power system 210 can include a prime mover, a transmission, and other components for generating and delivering power for movement of the vehicle 200 (e.g., drive shafts, differentials). The power system 210 provides the motive force and communicates the same to at least one of the ground engagement members 202 to power movement of the vehicle 200. Example prime movers include internal combustion engines, two stroke internal combustion engines, four stroke internal combustion engines, diesel engines, electric motors, hybrid engines, and other suitable sources of motive force. To start the prime mover, the vehicle 200 can include a vehicle start system 212. The type of vehicle start system 212 depends on the type of prime mover used. In an example, the prime mover is an internal combustion engine, and the vehicle start system 212 is one of a pull start system and an electric start system. In another example, the prime mover is an electric motor, and the vehicle start system 212 is a switch system which electrically couples one or more batteries to the electric motor. In examples, vehicle start system 212 includes a key, key fob, or the like.

The transmission is coupled to prime mover. In examples, the transmission includes a shiftable transmission and a continuously variable transmission (CVT). In an example implementation, the CVT is coupled to the prime mover, and the shiftable transmission is in turn coupled to the CVT. In one example, the shiftable transmission includes a forward high setting, a forward low setting, a neutral setting, a park setting, and a reverse setting. The transmission can be further coupled to at least one differential, and the at least one differential is in turn coupled to at least one ground engaging member 202. The vehicle 200 further includes a plurality of suspension systems which couple the ground engaging members 202 to the frame 204.

The vehicle 200 further includes braking and traction systems 214. The braking and traction systems 214 can dynamically adjust braking force and drive torque to the ground engaging members 202 based on terrain, environmental conditions, operator input, present operation of the ground engaging members 202 (e.g., rotation speed), and/or the like. In some examples, the braking and traction systems 214 includes anti-lock brakes.

The vehicle 200 includes a steering system 216. The steering system 216 is coupled to at least one of the ground engagement members 202 to direct the vehicle 200. The steering system 216 can include one or more operator input devices such as a handle bar or steering wheel, power steering components, and/or other steering assist components to assist operator control of the vehicle 200.

The vehicle 200 can also include a plurality of sensors 220 configured to monitor various characteristics of the vehicle 200 and a battery 222 configured to provide power to various components of the vehicle 200. Example sensors include, but are not limited to, a Global Positioning System (GPS) sensor, an accelerometer, a conductive ball and socket, an ambient temperature sensor, an image sensor, a microphone, and a light detection and ranging (LIDAR) sensor, among other examples.

An operator interface 224 includes one or more input and/or output devices. For example, the operator interface 224 includes the landscape-oriented display 110, the portrait-oriented display 120, and/or one or more other input and/or output devices. Example input and/or output devices include levers, buttons, switches, touch screens, soft keys, lights, displays, audio devices, tactile devices, and other suitable input and/or output devices. The devices of the operator interface 224 can thus enable a user to provide inputs for controlling the operation of the vehicle 200 and to provide outputs to the user such as operating information of the various components of the vehicle 200. The haptic I/O device 105 can be a component of the operator interface 224 in example implementations.

As illustrated, the haptic I/O device 105 can include a position sensor 232, a mechanical actuator 234, a graphical indicator 236, an I/O device controller 238, a communication interface 240, and a power source 242. In examples, haptic I/O device 105 includes a rotary knob configured to be rotated by an operator to control functionality of the vehicle 200 and/or associated accessories. The rotary knob may rotate about an axis, such as an axis perpendicular to a surface on which (or within which) the knob is mounted. As another example, the knob rotates about an axis parallel to a surface on which (or in which) the knob is mounted. Any of a variety of configurations are therefore contemplated. While aspects are described in the context of such a rotary knob, it will be appreciated that any of a variety of other input device types may be used in other examples. For instance, similar aspects may be applied to a rocker switch or a slider, among other examples.

The position sensor 232 can provide a signal or other information for determining a position of the haptic I/O device 105. Such signal or information can indicate, or can be indicative of, as a degree of rotation of the knob, a position of a rocker switch, a position of a slider, and so on. In examples, the position sensor 232 is a hall effect sensor or a rotary encoder, among other examples. It will be appreciated that any of a variety of other techniques may be used to sense the position of haptic I/O device 105. For instance, if the mechanical actuator 234 is a stepper motor, the position sensor 232 may be omitted or otherwise be integrated into the stepper motor so the mechanical actuator 234 provides an indication of the position of the haptic I/O device 105.

In certain examples, the position sensor 232 can also include a sensor for detecting when the knob is pressed. Thus, an operator can depress the knob of the haptic I/O device 105 for providing further input. In an example implementation, the position sensor 232 includes one or more strain gauges for detecting whether the knob is pressed. The haptic I/O device 105 can dynamically configure press detection thresholds (e.g., for determining whether the knob is pressed). In an example, the haptic I/O device 105, or a controller associated with the haptic I/O device 105, can be configured to electronically set or determine the amount, or rate of change, of pressure applied to the knob that indicates that the knob is pressed or actuated. In another example, the haptic I/O device 105, or a controller associated with the haptic I/O device 105, can be configured to electronically set or determine the amount, or rate of change, of displacement of the knob that indicates that the knob is pressed or actuated.

The mechanical actuator 234 is configured to actuate the haptic I/O device 105. When the haptic I/O device 105 includes a knob, mechanical actuator 254 may be a motor (e.g., a brushless direct current motor) usable to rotate the knob. Accordingly, the mechanical actuator 234 may be used to simulate resistance, simulate one or more detents, simulate one or more end stops, maintain one or more return-to-position points, move the knob to provide output information, simulate feedback when the knob is pressed and released, and/or the like. The mechanical properties of haptic I/O device 105, including operation of the mechanical actuator 234, may be dynamically adjusted for enabling input and/or output for various functions. It will be appreciated that other mechanical actuators may be used in other examples, such as a linear actuator (e.g., in an instance where haptic I/O device 105 includes a slider) or an electromagnet (e.g., in an instance where haptic I/O device 105 includes a rocker switch).

As illustrated, the haptic I/O device 105 further includes the graphical indicator 236. Example graphical indicators include, but are not limited to, a graphical display and/or one or more light emitting diodes (LEDs). For example, the haptic I/O device 105 can include a display on the face of the knob and a directional lighting system comprising one or more LEDs arranged underneath the knob or in a light ring around the knob. Information may thus be conveyed via the graphical indicator 236, such as a number and/or frequency of detents, configured end stops, resistance associated with actuation of haptic I/O device 105, information relating to a selected mode, position or direction information, and/or the like.

The graphical indicator 236 can be configured to simulate actuation of the haptic I/O device 105. For instance, as an operator rotates the knob of the haptic I/O device 105, a user interface (UI) (e.g., a UI component such as an icon, sprite, image/graphic, button, field, or control) on a display of the graphical indicator 236 may similarly be rotated. In certain examples, the UI may be counterrotated, for example to maintain a desired orientation for the operator (e.g., in an instance where the display physically rotates in conjunction with haptic I/O device 105). Additionally, the graphical indicator 236 can be rotated (e.g., either to counteract rotation by the mechanical actuator 234 or to simulate actuation in absence of actual actuation by the mechanical actuator 234), lights can change a portion of illumination (e.g., the brightness of one or more lights can be adjusted, or one or more lights can be turned on or off), and so on.

The I/O device controller 238 can control the components and various properties of the haptic I/O device 105. For example, the I/O device controller 238 controls the number and/or strength of the detents, controls the resistance of haptic I/O device 105 during actuation, controls positioning of end-stops, control automated movement for outputting information, and so on. For instance, when the recreational vehicle is traversing bumpy terrain, detents simulated by the mechanical actuator 234 may be stronger as compared to smooth terrain. As another example, I/O device controller 238 dynamically changes the resistance of haptic I/O device 105, for instance to indicate an amount of winching force (e.g., a higher winching force is associated with higher haptic I/O device 105 resistance), force required for traversing terrain (e.g., a higher force is associated with the power system 210 outputting more power to traverse steep terrain), and/or other physical characteristics of the vehicle 200 and/or environment (e.g., if the haptic I/O device 105 is used to adjust a suspension characteristic of the vehicle 200, the haptic I/O device 105 resistance may correlate with suspension stiffness such that, for example, a higher resistance may be associated with higher suspension stiffness). The I/O device controller 238 can control the components and various properties of the haptic I/O device 105 based on profiles for different functions. The profiles can include data structures having data or other information that define or indicate the input that occurs (e.g., a type or other characteristic of an input received by the haptic I/O device) when the haptic I/O device 105 is interacted with, associated output generated by the haptic I/O device 105, presence and positioning of detents, detent strength, resistance, end stops, return-to-position points, force feedback, adjustments at different speeds and/or other contexts of the vehicle 200, and/or the like for the associated function. Example functions include vehicle tracking, map navigation, HVAC control, accessory control (e.g., winch, plow, etc.), electronic shifting, and so on. The data or information stored in the profiles can indicate how the haptic I/O device 105 responds to input received at the haptic I/O device 105, or a type, frequency or other characteristic of output provided by haptic I/O device 105. The haptic I/O device 105 can include a memory for storing the profiles, the vehicle 200 can store the profiles externally to the haptic I/O device 105, and/or the profiles can be retrieved or obtained from devices or controllers external to the haptic I/O device 105 or the vehicle 200.

The communication interface 240 is configured to enable communication between the haptic I/O device 105 and the vehicle 200 (e.g., one or more controllers of the vehicle 200). Communication may be wired (e.g., via universal serial bus (USB) and/or a controller area network (CAN) bus), wireless (e.g., via BLUETOOTH and/or infrared), and/or optical, among other examples.

The power source 242 powers the mechanical actuator 234, I/O device controller 238, and/or communication interface 230, among other examples. The power source 242 may include a battery, a set of contacts (e.g., such that power may be received from power system 210), and/or an inductive receiver (e.g., such that power may be wirelessly received from the vehicle 200), among other examples.

While FIG. 2 includes example aspects of the haptic I/O device 105 according to aspects described herein, it will be appreciated that any of a variety of other configurations are contemplated. For example, the graphical indicator 236 may be omitted. Similarly, another example haptic I/O device 105 may be powered by another component of the vehicle 200 or not require power, and the power source 242 may not be included. The mechanical actuator 234, I/O device controller 238, and/or the like may be omitted in certain example implementations.

In an unpowered example (e.g., a configuration where the haptic I/O device 105 passively communicates with vehicle 200), the communication interface 240 may include an arrangement or pattern of capacitive pads, which are thus sensed by a controller of the vehicle (e.g., via a touch screen or capacitive panel of the vehicle). In such an example, a first portion of the capacitive pads may indicate a device type, while a second portion of the capacitive pads may be configured to change based on actuation of the haptic I/O device 105 by a vehicle operator (thereby communicating the actuation via the capacitive pads to the controller accordingly).

While examples are described in the context of a single haptic I/O device, it will be appreciated that, in some examples, multiple such devices may be used. For example, a set of haptic I/O devices may be linked such that input to a first haptic I/O device is reflected at a second haptic I/O device. As another example, input at the first haptic I/O device may affect (e.g., restrict, limit, disable, or enable) the ability to provide input via the second haptic I/O device. As a further example, multiple haptic I/O devices may each present information and/or control different functionality in association with the same mode (e.g., using a first device to control temperature and a second device to control a fan for a vehicle HVAC system).

The vehicle 200 further includes a vehicle controller 260 having at least one processor 262 and at least one memory 264. The vehicle controller 260 is configured to control the various components of the vehicle 200. The vehicle controller 260 can be operatively coupled to the plurality of sensors 220 to receive information the sensors 220 collect of various parameters of the vehicle 200 or the environment surrounding the vehicle 200. The vehicle controller 260 performs certain operations to control one or more subsystems of other vehicle components, such as the power system 210, the braking and traction system 214, the steering system 216, the sensors 220, the battery 222, the operator interface 224, the haptic I/O device 105, and/or the like. In certain examples, the vehicle controller 260 forms a portion of a processing subsystem including one or more computing devices having memory, processing, and communication hardware. The vehicle controller 260 may be a single device or a distributed device, and the functions of the vehicle controller 260 may be performed by hardware and/or as computer instructions on a non-transitory computer readable storage medium, such as the memory 264. The vehicle controller 260 may communicate with systems of vehicle 200 using any of a variety of protocols, including, but not limited to, a CAN bus, an Ethernet or BroadR-R each connection, a fiber connection, a USB connection, and/or a wireless connection.

The vehicle controller 260 may control power output of one or more engines and/or electric motors (e.g., a traction motor and/or an electric motor) of the power system 210, the pressure and frequency of the actuation of one or more brake calipers of braking and traction systems 214, a steering angle of one or more ground engaging members 202 via the steering system 216, and/or the like. While example aspects are described herein with respect to the braking and traction systems 214 and/or the steering system 216, it will be appreciated that similar techniques may be used in instances where the power system 210 includes an individual drive motor for each ground engaging member 202. For example, a set of drive motors may be used to provide vehicle stability aspects to control of the braking and traction systems 214 and/or the steering system 216.

The haptic I/O device 105 can control operation of one or more devices of the operator interface 224. For example, the haptic I/O device 105 can receive input for a user to interact with a UI displayed via the operator interface (e.g., displayed on the landscape-oriented display 110 or the portrait-oriented display 120). Therefore, the haptic I/O device 105 can provide tactile control for devices that may be difficult to use in certain contexts, such as touchscreens. The haptic I/O device 105 can also receive output information from the operator interface 224, such as to display a UI or operate the directional lighting system of the graphical indicator 236. The haptic I/O device 105 can communicate directly with devices of the operator interface 224 or the vehicle controller 260 can facilitate the haptic I/O device 105 controlling devices of the operator interface 224 and/or receiving output. Thus, the haptic I/O device 105 can indicate or provide input to the vehicle controller 260 for the vehicle controller 260 to adjust operation of the vehicle 200 according to the inputs.

The I/O device controller 238 can identify how to operate based on user input, input from other components of the vehicle 200, and/or the like. For example, the vehicle controller 260 and/or the devices of the operator interface 224 can provide information to the I/O device controller 238 so the I/O device controller 238 can determine the current function the haptic I/O device 105 should enable input and output for, identify the profile of the current function, and cause the haptic I/O device 105 to operate according to the profile. The vehicle controller 260 can also enable other systems to share information with the haptic I/O device 105, such as the power system 210, the braking and traction systems 214, the steering system 216, the sensors 220, the battery 222, and/or the like.

A network system 270 can include one or more processors 272 and one or more memories 274 and is configured to communicate with external systems. For example, the network system 270 can enable communication via a network 280 (e.g., a local area network, a peer-to-peer network, the Internet, etc.) with remote devices 282, other vehicles 284, and/or the like. In examples, the network system 270 communicates via a BLUETOOTH or WI-FI protocol using a radio frequency antenna. The network system 270 controls the pairing of devices to the vehicle 200 and the communications between the vehicle 200 and the remote devices 282 and/or other vehicles 284. It will be appreciated that any number of networks, network types, and associated technologies may be used. For example, the network system 270 may include a cellular antenna, a satellite antenna, and/or one or more components for wired communication.

In certain examples, the power system 210 provides power for other functionality of vehicle 200, such as the braking and traction system 214, the steering system 216, the sensors 220, the battery 222, the operator interface 224, the haptic I/O device 105, and/or the network system 270. In some instances, the power system 210 includes a high-voltage power system associated with high-voltage vehicle functionality, as well as a low-voltage power system that is associated with the vehicle controller 260 and other low-voltage vehicle functionality.

The vehicle controller 260 may receive user input via the haptic I/O device 105, the operator interface 224 and/or the network system 270 and control the power system 210, the braking and traction system 214, the steering system 216, the sensors 220, the battery 222, the operator interface 224, the haptic I/O device 105, and/or the network system 270, accordingly. The vehicle controller 260 can also automatically affect operation of vehicle 200 in response to detected conditions of the vehicle and/or the environment in which the vehicle is operating.

The haptic I/O device 105 is illustrated as including a connection to the vehicle controller 260 and a connection to operator interface 224. In examples, the haptic I/O device 105 includes the I/O device controller 238 for communicating with the vehicle controller 260 (and/or any of a variety of other vehicle systems, for example via a CAN bus of vehicle 200) and/or is controlled by the operator interface 224, such as when the haptic I/O device 105 operates as a secondary device to the operator interface 224. For instance, the operator interface 224 can include an IVI system, which may be extended via the haptic I/O device 105. It will be appreciated that one or both connections may be omitted and/or the haptic I/O device 105 may control any of a variety of other vehicle functionality according to aspects described herein.

Accessories 290 can connect to the vehicle 200 for operation. The accessories 290 can connect to various components of the vehicle 200 based on the accessory type and functionality. The accessories can include light systems, winches, plows, sensors, I/O devices, HVAC devices, audio and entertainment devices, and/or the like. The haptic I/O device 105 can identify connected accessories 290, identify profiles associated with the identified accessories, and enable input and output functionality for the accessories 290. In certain examples, the vehicle controller 260 identifies the accessories 290 and communicates with the haptic I/O device 105 so the haptic I/O device 105 enables the input and output functionality for the accessories 290.

In examples, the haptic I/O device 105 and other components of the vehicle 200 are configured to communicate via a CAN bus, or similar vehicle communication network, interface. The CAN bus can enable identification of the vehicle components 200, including the various accessories 290 and to identify external devices, such as the remote devices 282 and the other vehicles 284. The CAN bus can also enable sharing of profiles for the haptic I/O device 105 to facilitate various functions, enable real-time monitoring of the various components, or enable status updates and real-time feedback control.

The processors (e.g., of the I/O device controller 238, the one or more processors 262 of the vehicle controller 260, the one or more processors 272 of the network system 270, etc.) may include one or more processing units, or programmable circuits. A processing unit is a physical device or article of manufacture comprising one or more integrated circuits that selectively execute software instructions. In various examples, the processors is implemented in various ways. For example, the processors can be implemented as one or more physical or logical processing cores. In another example, the processors can include one or more separate microprocessors. In yet another example, the processors can include an application-specific integrated circuit (A SIC) that provides specific functionality. In yet another example, the processors provide specific functionality by using an ASIC and by executing computer-executable instructions.

The memories (e.g., the memory of the haptic I/O device 105, the memory 264 of the vehicle controller 260, the memory 274 of the network system 270, etc.) can be implemented using various types of computer storage media, and generally includes at least some tangible media. In some examples, the memories are implemented using entirely non-transitory media. In accordance with the present disclosure, the term computer readable media as used herein may include computer storage media and communication media. As used in this document, a computer storage medium is a device or article of manufacture that stores data and/or computer-executable instructions. Computer storage media may include volatile and nonvolatile, removable and non-removable devices or articles of manufacture implemented in any process or technology for storage of information, such as computer readable instructions, data structures, program modules, or other data. By way of example, and not limitation, computer storage media may include various types of dynamic random access memory (DRAM), solid state memory, read-only memory (ROM), electrically-erasable programmable ROM, magnetic disks (e.g., hard disks, floppy disks, etc.), and other types of devices and/or articles of manufacture that store data. Communication media may be embodied by computer readable instructions, data structures, program modules, or other data in a modulated data signal, such as a carrier wave or other transport mechanism, and includes any information delivery media. A modulated data signal may be a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

### Example Haptic I/O Device Components

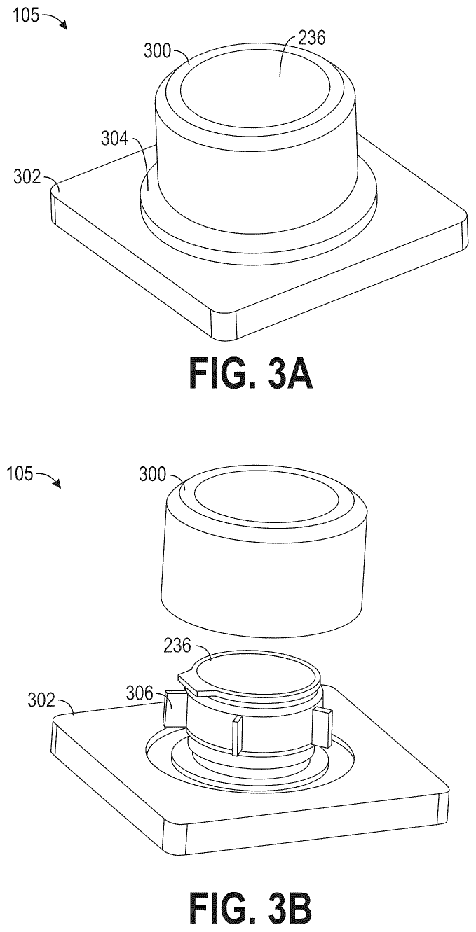

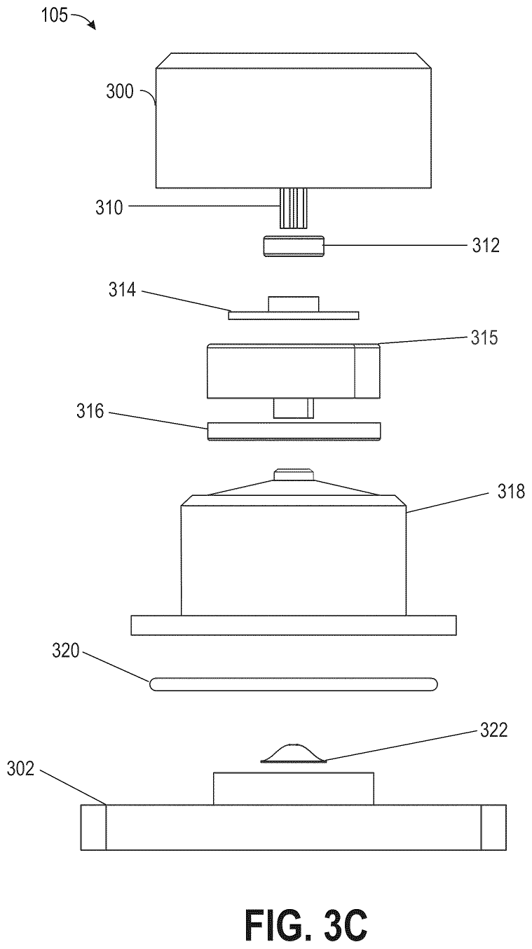

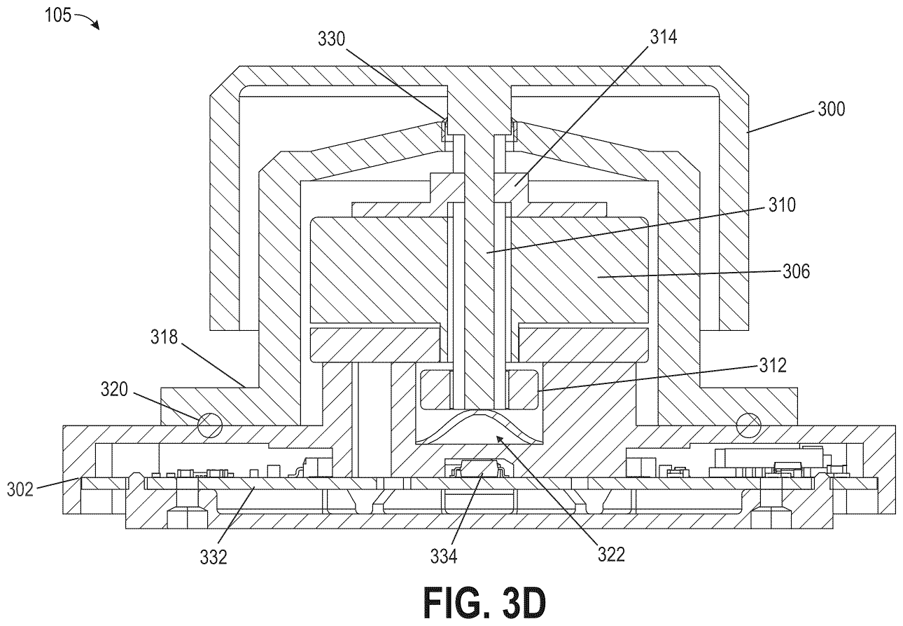

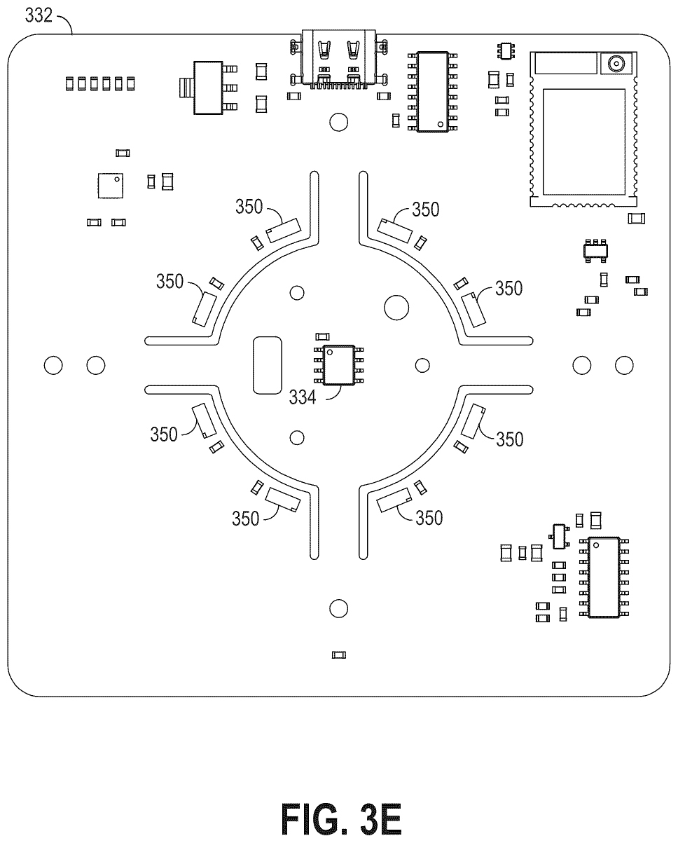

FIGS. 3A-3E illustrate an example haptic I/O device 105. The illustrated haptic I/O device 105 includes a haptic-enabled rotary knob 300, a base 302, and a directional light system 304. A graphical indicator 236 comprising a display is positioned at the face of the knob 300 to provide visual output and, in some implementations, receive input (e.g., via touch). The display can inform the user of changes in functionality of the haptic I/O device 105 as the user cycles through modes or uses the haptic I/O device 105 in some examples. The base 302 can contain components of the haptic I/O device 105, including the position sensor 232, the I/O device controller 238, the communication interface 240, the power source 242, and/or the like. The base 302 can be sized differently in other examples, including being integrated into the vehicle 200 itself, so the I/O device controller 238, the communication interface 240, the power source 242, etc. are not necessarily in the same position as the knob 300.

The illustrated directional light system 304 is a ring light and can be raised from the base 302 as shown or flush with the base 302. In other examples, the directional light system 304 includes lights positioned within the knob 300. The knob 300 is mounted on top of a brushless direct current (DC) motor 306. The brushless DC motor 306 can be another mechanical actuator 234 in other examples.

In some examples, the knob 300 can include a physical indicator of where the knob 300 is considered to be pointing or otherwise oriented. In further examples, the graphical indicator (e.g., via the display and/or the directional light system 304) can indicate where the knob 300 is considered to be pointing or otherwise oriented.

FIG. 3C illustrates an exploded view of the haptic I/O device 105 to illustrate views of the components covered by the knob 300. FIG. 3D illustrates a cross-sectional view of the haptic I/O device 105, including the components covered by the knob 300. FIG. 3D thus illustrates the components as positioned in the assembled haptic I/O device 105. A different combination of components can be included in the haptic I/O device 105 in other examples.

As illustrated in FIG. 3C, the haptic I/O device 105 includes the knob 300, the base 302, a knob shaft 310, a magnet 312, a knob-actuator interface 314, a rotor 315 of the brushless DC motor 306, a stator 316 of the brushless DC motor 306, an enclosure 318, an environmental seal 320, and a tactile dome 322. FIG. 3D further illustrates a rotary environmental seal 330, a printed circuit board (PCB) 332 in the base 302, and a position encoder 334.

The knob shaft 310 is an elongated (e.g., cylindrical or similar shaped) member of the knob 300 that connects the knob 300 to the brushless DC motor 306 and/or other components of the haptic I/O device 105. In certain examples, the knob shaft 310 is a grooved or ridged shaft that fits into a grooved or ridged opening of the knob-actuator interface 314 to enable torque to be transmitted to the knob 300 by the brushless DC motor 306 without slippage. The knob-actuator interface 314 can connect to the rotor 315 to cause the knob 300 to rotate when the rotor 315 rotates. In other examples, the brushless DC motor 306 can include protrusions such as those illustrated in FIG. 3B operable to engage with openings of the knob 300 so the brushless DC motor 306 contacts and can move the knob 300.

The magnet 312 can connect to the knob shaft 310 (e.g., via a grooved or ridged opening) so the magnet 312 rotates when the brushless DC motor 306 causes the knob 300 to rotate. The position sensor 232 can monitor the rotation of the magnet 312 to identify the positional rotation of the knob 300. For example, the brushless DC motor 306 and knob 300 rotation is recorded with the position sensor 232 being the position encoder 334. The position encoder 334 can be a magnetic encoder configured to identify the rotation of the magnet 312. As a user and/or the brushless DC motor 306 spins the knob 300, the angular position of the knob 300 is processed based on the position sensor 232 monitoring the magnet 312. The I/O device controller 238 can cause the brushless DC motor 306 to engage and disengage according to the current profile to simulate feedback, including detents with variable strength, frequency, and position, rotational resistance, end stops, return-to-position force, force feedback, and/or the like. For example, the brushless DC motor 306 can engage when the knob 300 is rotated to a position with a detent to provide resistance so the user feels the detent while interacting with the knob 300. The brushless DC motor 306 can disengage as the user continues rotating the knob 300 away from the detent position.

The enclosure 318 is configured to cover the interior components of the haptic I/O device 105. The vehicle 200 may be exposed to various conditions such as moisture, rain, snow, mud, dust, cold, heat, and so on. The enclosure 318 can create a seal or otherwise provide ingress protection for the components of the haptic I/O device 105. The environmental seal 320 can be a perimeter gasket, O-ring, over-molded elastomeric seal, and/or the like that creates a seal between the enclosure 318 and the base 302. The rotary environmental seal 330 can be a perimeter gasket, O-ring, over-molded elastomeric seal, and/or the like that can create a seal between the enclosure 318 and the knob 300 or knob shaft 310. Thus, the enclosure 318, the environmental seal 320, and the rotary environmental seal 330 can keep moisture, dust, mud, etc. from entering the haptic I/O device 105 and interfering with operation of the components. The enclosure 318, the environmental seal 320, the rotary environmental seal 330, and/or other environmental protection components of the haptic I/O device 105 can be designed to comply with one or more industry standards (e.g., IP65, IP67, IP68, IP69, IP69K, etc.), the haptic I/O device 105 can operate within a temperature range, the haptic I/O device 105 can resist vibration and impacts, and/or the like. While the enclosure 318 is illustrated as extending past the base of the knob 300 in FIG. 3D, the enclosure 318 can be contained within the knob 300 in other examples.

The tactile dome 322 is a dome-shaped structure positioned to be depressed by the knob shaft 310 when the knob 300 is depressed (e.g., provided axial force). The tactile dome 322 is configured to deform under pressure applied by the knob shaft 310 to provide tactile feedback to the user indicating the knob 300 has been depressed and for electrical contact functionality so the I/O device controller 238 can identify when the knob 300 is pressed. The tactile dome 322 can be made of a flexible, conductive or non-conductive material and dimensioned to provide a defined actuation force threshold. When the knob 300 is pressed, the tactile dome 322 can collapse or otherwise deform to generate a perceptible tactile response to the user and/or close an underlying circuit for the I/O device controller 238 to identify the knob 300 is pressed. When the force is released, the tactile dome 322 can return to its original shape. Thus, the tactile dome 322 is an example component for enabling the knob 300 to be pushed inward like a button. In certain examples, one or more strain gauges are used to detect such a press instead of the tactile dome 322 completing a circuit. When the I/O device controller 238 determines the knob 300 has been pushed sufficiently (e.g., according to a current profile, software configuration), the I/O device controller 238 can cause the brushless DC motor 306 to kick or otherwise operate to indicate the press is registered. The I/O device controller 238 can cause the brushless DC motor 306 to kick or otherwise operate (e.g., less strong than when in response to the press) when the knob 300 is released to simulate an actual button press. It will be appreciated that, in other examples, push functionality may be implemented mechanically, via a combination of other components, etc.

The axial force input of the haptic I/O device 105 can enable transition to various sub-functions or other functions. For example, in a navigation mode, axial force can switch the knob 300 input between zooming a map, panning, etc. In a shifter mode, axial force can switch the knob 300 to a specific sub-function of the currently selected gear. In an accessory mode, the axial force can switch control between multiple accessories 290. Thus, the axial force enables additional functionality of the haptic I/O device 105.

FIG. 3E illustrates the PCB 332. The PCB can include the position encoder 334 (or other position sensor 232), the I/O device controller 238, the communication interface 240, and/or the like. Additionally, the PCB 332 can include one or more lights 350 that make up the directional light system 304. Thus, in the illustrated example, the directional light system 304 does not include a ring light. The lights 350 can be LEDs capable of displaying one or more colors at one or more intensities or brightnesses. In the illustrated example, there are six lights 350, but there can be other numbers of lights in further examples.

### Example Haptic I/O Device Functionality

As described and illustrated with respect to FIGS. 2 and 3A-3E, the haptic I/O device 105 can act as a configurable device for enabling input and output for multiple functions. The haptic I/O device 105 can also combine the benefits of a touchscreen, such the landscape-oriented display 110, the portrait-oriented display 120, and/or one or more other input and/or output devices of the operator interface 224 with the tactility of a knob. Such aspects may be useful in instances where an operator instead focuses on a trail, in rough terrain, and in gloved environments. Thus, the disclosed aspects and functionality of the haptic I/O device 105 may increase safety, tactility, and configurability of the user experience (e.g., in the vehicle 200).

Functionality of the haptic I/O device 105 for the various functions can include mechanical actuator 234 (e.g., the brushless DC motor 306) simulating detents with variable strength, frequency, and position, rotational resistance, end stops, return-to-position force (e.g., to return to a position of a detent), force feedback, and/or the like. The position sensor 232 can enable detection of angular position and velocity, enabling real-time feedback control for the functionality of the haptic I/O device 105.

For detents, the mechanical actuator 234 can apply force (e.g., torque pulses, holds) at the defined intervals of the detents to provide feedback. The mechanical actuator 234 can vary the detent strength (e.g., via the force applied by the brushless DC motor 306), spacing, and behavior based on the current function. In some examples, the graphical indicator 236 (e.g., the display and/or the directional light system 304) indicates the location of the detents and/or when a detent is reached. For example, the display can include visual indicators of detent position and/or provide visual indication of when a detent is reached (e.g., incrementing or decrementing a number, indicators along the display), the directional light system 304 can pulse or otherwise indicate when a detent is reached, among other examples.

For a return-to-position force, the mechanical actuator 234 can be configured to apply a restoring force to return the knob 300 to a set position (e.g., detent position) when the knob 300 is rotated and subsequently released. For example, the position sensor 232 determines the position of knob 300 when the knob 300 is released so the I/O device controller 238 can cause the mechanical actuator to return the knob 300 to the set position, such as one of the detent positions, the upward position of the knob 300 as an operator would view the knob 300 in the vehicle 200, etc. Additionally, an amount of pushback torque can be increased over time as the knob 300 is rotated further away from the set position so the knob 300 becomes harder to twist (e.g., more force is required to twist the knob 300). In some examples, the graphical indicator 236 indicates the location of the set position. For example, the display can include visual indicators of the set position, provide visual indication when the knob 300 is not at the set position and when the knob 300 is at the set position, the directional light system 304 emit be one color is not at the set position and emit another color when the knob 300 is at the set position, etc.

In certain examples, the haptic I/O device 105 can function as a switch or option selector, jumping between set positions such as detents or end stops. The mechanical actuator 234 can provide resistive force when moving away from a set position and guidance force moving toward another set position. Thus, the knob 300 is biased to settle or otherwise snap into place at one of the set positions. The set positions can be reinforced by return-to-position force, end stops, dwell torque, and/or the like. In certain examples, there are two set positions, such as for the haptic I/O device 105 to act an on/off switch. In other example, there are three or more set positions, such as for the haptic I/O device 105 to enable mode selection, shifting gears, and/or the like.

To implement end stops at one or more positions for indicating that input is not available beyond a set range, the haptic I/O device 105 can prevent rotation or otherwise indicate an end stop is reached. For example, the haptic I/O device 105 can be configured to allow the knob 300 to rotate in a direction for a quarter rotation, a half rotation, a full rotation, three full rotations, and so on before encountering an end stop. When the end stop is encountered, the mechanical actuator 234 can apply maximum force to prevent or resist the knob 300 from spinning further or provide resistance to indicate to the user that the end stop has been reached. In other examples, the mechanical actuator 234 can apply a different percentage of force to provide resistance, generate a pattern of force, and/or the like to the indicate an end stop is reached. If an end stop is passed when a user releases the knob 300, the mechanical actuator 234 can rotate the knob 300 back to the end stop position to simulate mechanical compliance with the end stop. Thus, a return-to-center force can be implemented when an end stop is passed.

In certain examples, the graphical indicator 236 can visually indicate the end stop positions (e.g., via the display and/or the directional light system 304). For example, the directional light system 304 can emit one color when the rotation has not reached an end stop and change to a second color when the end stop is reached. In other examples, the directional light system 304 can illuminate sections of the knob 300 where the end stops are located.

In some examples, the haptic I/O device 105 can act as a frictionless or low friction rotating knob. When a user stops touching the knob 300, the mechanical actuator 234 can continue rotating the knob 300 at the same velocity the knob 300 was rotating when release until the user stops the rotation or after slowly reducing the rotational velocity, thereby simulating a frictionless or low friction knob 300. In example implementations, the haptic I/O device 105 can maintain the velocity until a set position is reached.

Various combinations of the described functionality of the haptic I/O device 105 can be implemented. For example, a profile for a function can include a number of detents, set positions, return-to-position points, and so on. The knob 300 could click (e.g., detents) while being rotated and at the same time the haptic I/O device 105 can apply torque to return-to-position or a set point for instance. In another example, as an operator zooms in and out of a map with the knob 300 (e.g., as may be displayed by an IVI or via haptic I/O device 105), the haptic I/O device 105 may provide simulated detents to indicate a sufficient rotation to increase/decrease an associated zoom rate.

### Haptic I/O Device Active Feedback During Standby

In addition to the above-disclosed aspects related to user actuation of the haptic I/O device 105, the haptic I/O device 105 can provide active feedback (e.g., to provide visual information to the user, which may be conveyed, at least in part, via rotation of the knob 300). In examples, the rotation of the knob 300 can be coupled with a fixed indicator in the knob 300, information displayed via the graphical indicator 236, and/or the like. The haptic I/O device 105 can provide active feedback when an operator is not actively using the haptic I/O device 105 (e.g., after a predetermined period, after a user-configurable period). An operator can interrupt the active feedback by interacting with the haptic I/O device 105.

The active feedback can indicate output information associated with one or more systems of the vehicle 200. For example, as the vehicle's volume changes (e.g., via a display of an IVI), the knob 300 can rotate to show the change. Similarly, the haptic I/O device 105 can convey other relevant information of the vehicle 200, such as indicating other audio system characteristics (e.g., bass level, treble level), power system characteristics (e.g., rotations per minute (RPM), temperature, CVT position, transmission state), and suspension characteristics (e.g., active suspension compression ration), among other examples.

The haptic I/O device 105 can also provide active feedback to indicate time measurements. The haptic I/O device 105 can act as a clock, for example matching the hour hand to a relative position of the knob 300 or an indication by the graphical indicator 236. For example, the directional light system 304 can emit light to indicate the day/night cycle, the position of the minute or hour hand, etc. The haptic I/O device 105 can also act as a timer, rotating down to a final position to indicate time remaining. The graphical indicator 236 can provide supplemental indications, such as a countdown on the display, the directional light system 304 illuminating a shrinking portion of the available 360 degree space to indicate the time remaining, the directional light system 304 changing colors to indicate the time remaining, and/or the like. The timer can be configured to act as a dedicated widget, and the time remaining can be adjusted simply by rotating the knob 300. In other implementations, the timer will continue in the background if the user controls the knob 300 for other functions and will resume visual knob indication when the knob 300 enters an idle, standby state.

The knob 300 and/or the graphical indicator 236 could also be configured to act as an indicator for tracking another vehicle 284 (e.g., referred to as “buddy tracking”) while the display is used for another application, as will be described herein. Additional aspects of buddy tracking are disclosed in U.S. Pat. No. 11,963,064 (titled “Recreational Vehicle Group Management System”) and U.S. Publication No. 3022/0057227 (titled “Recreational Vehicle Interactive Telemetry, Mapping and Trip Planning System”), the entire disclosures of which are hereby expressly incorporated herein by reference for all purposes. Thus, the haptic I/O device 105 can interface with on-vehicle trail data and coordinate with tracking systems and implementations to indicate the path to take to maintain course with the other vehicle 284 or group of vehicles 284 using turn-by-turn directions, indicating the relative position of the nearest other vehicle 284, and/or the like. In an example where turn-by-turn directions are being indicate, the haptic I/O device 105 can indicate which path to take, such as at a fork in the road, to stay with or follow the additional vehicle(s) 284. In further examples, the haptic I/O device 105 can utilize positioning data such as GPS data on-vehicle to guide the operator to a specific way point rather than another vehicle 284. Example implementation can interface with trail data to provide turn-by turn directions or exact direction functionality. In additional examples, the haptic I/O device 105 can act as a cardinal compass.

### Example Directional Light System Functionality

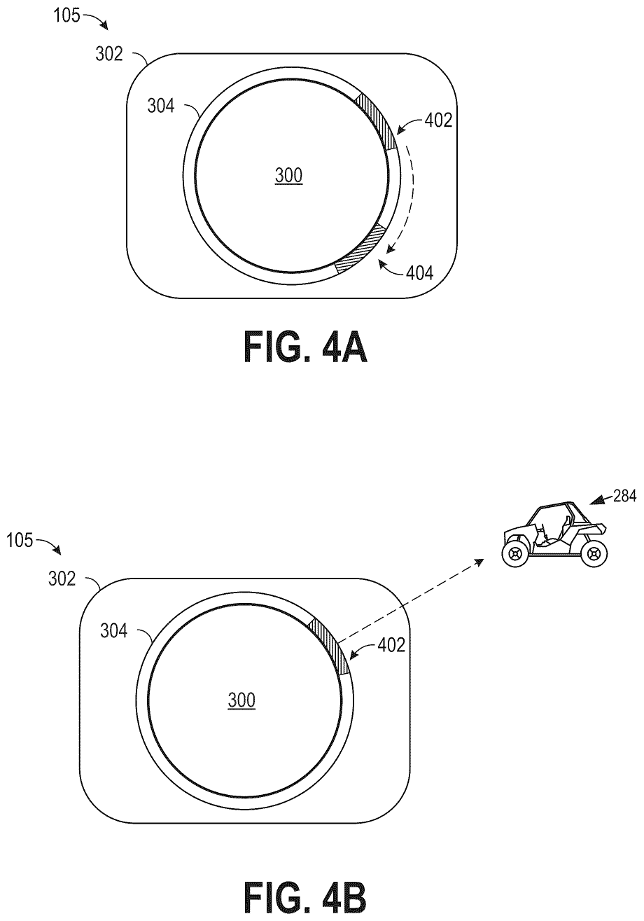

FIGS. 4A and 4B illustrate example functionality of the directional light system 304. FIG. 4A illustrates the directional light system 304 illuminating a first portion 402 of the available 360 degrees of space around the knob 300. In an example, the directional light system 304 stops illuminating the first portion 402 and begins illuminating a second portion 404 of the available 360 degrees of space around the knob 300. For example, the directional light system 304 can transition to the second portion 404 in response to the knob 300 being rotated, to indicate a waypoint (e.g., to a destination or another vehicle 284), and/or the like. FIG. 4B illustrates the directional light system 304 illuminating a first portion 402 to indicate the position of the other vehicle 284 relative to the vehicle 200. The haptic I/O device 105 can update the portion the directional light system 304 illuminates to continuously indicate the position of the other vehicle 284 relative to the vehicle 200.

As described herein, the directional light system 304 can provide additional functionality not illustrated. For example, the directional light system 304 can emit different colors to indicate various information, pulse or otherwise turn on or off to indicate received input or indicate output information, illuminate other portions of the available space, and so on.

### Example Functions for Haptic I/O Device Functionality

The I/O device controller 238 can control the components and various properties of the haptic I/O device 105 based on profiles for different functions. The profiles can define the presence and positioning of detents, detent strength, resistance, end stops, return-to-position points, force feedback, adjustments at different speeds and/or other contexts of the vehicle 200, and/or the like for the associated function. In examples, the haptic I/O device 105 can receive (e.g., be updated/flashed to load different function profiles) different function profiles. The haptic I/O device 105 and/or other components of the vehicle 200 can store the profiles. Such aspects may thus be used to support vehicle features and/or to offer smart accessory integration, among other examples. As another example, an over-the-air update may be used to support new features and/or to offer first-party accessory adoption.

The haptic I/O device 105 can support functionality for any number of functions. Example functions include controlling the angle of a plow, controlling a winch, controlling audio devices (e.g., volume, EQ, track control, radio tuning), HVAC control, operating as a shifter, drive mode selection, drive gear selection (e.g., 2WD, 4WD, turf), suspension tuning, buddy tracking, waypoint setting, controlling a map, controlling vehicle lighting, controlling the operator interface 224, controlling characteristics of the operator interface 224 (e.g., brightness), controlling steering (e.g., for towing reversal), agricultural applications (e.g., direction of sprayers), controlling a bed (e.g., dump control rate and angle), and gauge selection, among other examples.

For controlling the audio system for example, the associated profile can define detent positions, detent strength, end stops, etc. for adjusting volume, EQ, radio tuning, and the like, define different sequences of button presses for track control, and/or the like. For HVAC control, since the knob can be configured during operation of the vehicle, a new configuration can be applied as though the knob were always at the origin. The profile can define fine detents for temperature selection and fan speed selection in selectable increments, define a press of the knob 300 to reconfigure the input to be for temperature or fan speed, etc.

For map control, the profile can define a return-to-position set point when the knob 300 is utilized for zooming in and out of the map where no input is registered (e.g., resting position). As the knob 300 is rotated, the user will feel torque pulling the knob to the set point. The profile can define actuation points a distance from the set point where the map will begin zooming in or out. The profile can define additional actuation points a further distance from the set point where the zoom speed is increased when the knob 300 is rotated past the additional actuation points. Once the user releases the knob 300, the knob 300 returns to the set point.

For functions that include a selection of options, such as a shifter, turning on and off systems such as vehicle lighting, gear selection, and drive mode selection, the associated profiles can define a layout of set positions for the respective options, and the knob 300 is biased to settle or otherwise snap into place at one of the set positions as described above. A profile for controlling a light bar may have ten detents positioned for the ten possible brightness levels of the light bar. Profiles for enabling two options such as moving or turning a component forward or backward, up or down, left or right, or the like, such as winch control, plow control, steering control, suspension tuning, and bed control, can include a return-to-position set point where no input occurs and enable the two movements by turning the knob 300 in a respective direction. Thus, the profiles of the various described functions can define the presence and positioning of detents, detent strength, resistance, end stops, return-to-position points, force feedback, adjustments at different speeds and/or other contexts of the vehicle 200, and/or the like so a user can provide input the haptic I/O device 105 can accurately interpret for control of components of the vehicle.

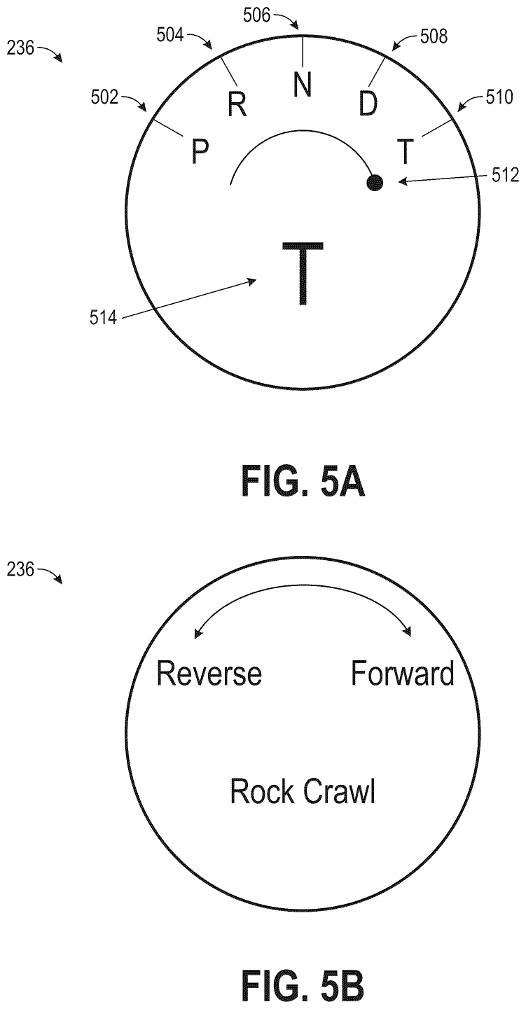

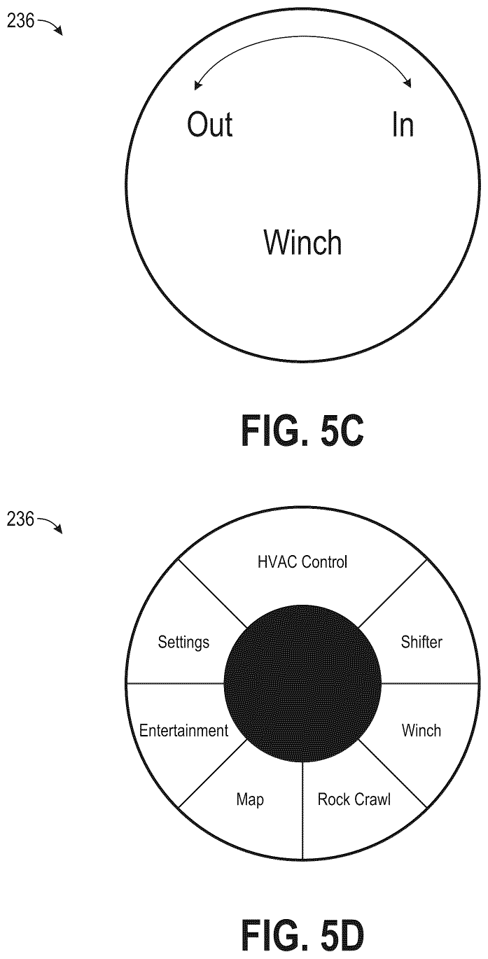

FIGS. 5A-5D illustrate example UIs displayed by the graphical indicator 236 for various functions. Other UIs not illustrated can also be displayed for other functions in further examples. FIG. 5A illustrates an example UI display by the graphical indicator 236 for a shifter function. The shifter function enables an operator to shift gear positions of the vehicle 200 transmission. In the illustrated example, the shifter includes options for park (P), reverse (R), neutral (N), drive (D), and tow (T). There may be any other combination of shifter options in other examples.

The shifter profile includes a first set position 502 for park, a second set position 504 for revers, a third set position 506 for neutral, a fourth set position 508 for drive, and a fifth set position 510 for tow. The shifter profile can also define a visual indication 512 of the selected transmission gear and a shifter selection 514 showing a larger size of the selected gear, both illustrated as indicating tow is the selected gear. The shifter profile can define the layout of the set positions 502, 504, 506, 508, 510 and define the knob 300 to bias to settle or otherwise snap into place at one of the set positions 502, 504, 506, 508, 510 as described above. Therefore, the haptic I/O device 105 will move between the set positions 502, 504, 506, 508, 510 to enable a gear selection and rest at the respective position of the currently selected gear. In some examples, the shifter profile can define that the haptic I/O device 105 automatically causes the shifter to move to park (e.g., the first set position 502) when the vehicle 200 is turned off (e.g., via the vehicle start system 212) or when the knob 300 is pressed.

In certain examples, the gear will not shift to a new selection until the user presses the knob 300 after the knob 300 has been rotated to the desired gear selection. The shifter profile can also enable a user to press the knob 300 when a gear selected. For example, when the tow mode is selected, the haptic I/O device 105 can then receive input for tow specific functions. The graphical indicator 236 can then display the tow options (e.g., rotation of the knob 300 for steering control when reversing the vehicle 200). The other gears may also have additional input functionality if the knob 300 is pressed while the gear is selected. For example, when drive is the current gear, pressing the knob 300 can enable the haptic I/O device 105 to receive input for drive gear selection (e.g., 2WD, 4WD, turf). In other examples, the shifter may include a profile that enables an operator to perform a shuttle shift, such as a shift from a selected forward gear to a selected reverse gear or a shift from a selected reverse gear to a selected forward gear (e.g., a previously selected). As an example, when the vehicle transmission or shifter is engaged in a selected forward gear, the haptic I/O device 105 may be rotated or actuated to select reverse or a specified reverse gear (e.g., the knob 300 may be rotated to position 505 (“R”) or another position indicative of a reverse gear), and the shifter or other vehicle controller (e.g., a transmission controller) may transition the vehicle to reverse, or to a previously selected reverse gear. In another example, when the vehicle transmission or shifter is engaged in a reverse gear (e.g., the knob 300 is at position 505 (“R”) or another position indicative of a reverse gear), the haptic I/O device 105 may be rotated or actuated to select drive or a specified forward gear (e.g., the knob 300 may be rotated to position 508 or a position indicative of a selected forward gear), and the vehicle shifter or other vehicle controller may transition the vehicle to the forward or a previously selected forward gear. In some examples, the vehicle shifter or other controller transitions the vehicle to forward or reverse gear without manual actuation (e.g., operator actuation) of the vehicle clutch.

The profile can also define the haptic feedback the haptic I/O device 105 provides. For example, if the operator selects park, the haptic I/O device 105 may provide haptic feedback indicating the vehicle has been placed into park. Such aspects are in contrast to a mechanical gear selector, where changes to a gear selection have an associated mechanical change to be affected to the mechanical gear selector. Rather, the state of the haptic I/O device 105 can be changed by controlling one or more graphical indicators of the device (e.g., such that a rotary knob 300 itself need not be moved). Thus, the disclosed haptic I/O device 105 may simulate various aspects of a physical gear selection knob while reducing or otherwise omitting additional hardware associated with automatically changing a physical state of the gear selection knob.

FIG. 5B illustrates an example UI display by the graphical indicator 236 for a terrain traversal function to assist with traversing terrain. FIG. 5C illustrates an example UI display by the graphical indicator 236 for controlling a winch. The profiles for the terrain traversal (e.g., rock crawl) and winch control can be similar because both are enabling two options. The rock crawl function can include an option for moving the vehicle 200 forward or in reverse, and the winch control function can include an option for moving the winch outward (e.g., release additional slack) or inward (e.g., retract the winch toward the vehicle 200). Thus, the profiles can have a return-to-position set point between the two options with the ability to rotate the knob 300 in either direction to select and effectuate one of the options.

The haptic I/O device 105 can provide dynamic force feedback to the user while being rotated to convey information about the function they are modifying, including for the rock crawl function and the winch control function. For example, the haptic I/O device 105 generates counter pressure as the user rotates the knob 300 to convey status beyond a normal configuration response. In some examples, such feedback can be stacked on top of other existing knob conditions according to aspects described herein. For example, when active feedback kicks in on a knob configuration with detents (e.g., set positions), the detent profile remains and the torque of the active feedback is overlaid on top of the detent configuration of the profile.

For winch control, the haptic I/O device 105 can determine rope load, current, temperature, and/or other conditions (e.g., via the sensors, via components of the accessory 290 winch, via the vehicle controller 260). The haptic I/O device 105 will operate according to a profile where the winch can be extended or retracted via rotation of the knob 300, for example rotating the knob 300 counter-clockwise to extend the winch and clockwise to retract the winch as illustrated in FIG. 5C. If the winch is equipped with a variable speed brushless motor, greater knob 300 rotation away from the return-to-position point can increase winch rotation speed for retraction and/or extension. As the winch pulls greater and greater loads, the counter pressure the haptic I/O device 105 exerts on the user's hand can increase, for example alerting the user of the increased strain or force on the winch. Additionally, if the winch overheats or needs to self-protect from excessive current draw, the haptic I/O device 105 can cease to provide feedback at all and becomes a free-spinning knob without any feedback or output. Thus, the haptic I/O device 105 can enable the user to control the winch and provide active feedback about the load the winch is pulling, whether operation of the winch needs to stop to protect the winch or vehicle 200, and/or the like.

For the rock crawl function, the haptic I/O device 105 can enable the user to cause the vehicle 200 to reverse by rotating the knob 300 in a counter-clockwise direction and cause the vehicle 200 to move forward by rotating the knob 300 in a clockwise direction in the example illustrated in FIG. 5B. Therefore, the haptic I/O device 105 acts as a hand-operated throttle to provide further control in rock crawling or other difficult terrain scenarios rather than using a throttle intended to be operated by foot. The rock crawl profile can enable the speed of reversing and moving forward to vary based on the degree the knob 300 is rotated away from the return-to-position point (e.g., increasing speed the further the knob 300 is rotated). The rock crawl profile can also define dynamic end stops, which may indicate to the user when a maximum velocity allowed in crawl mode is reached for reverse and/or forward. In certain examples, the haptic I/O device 105 and/or the operator interface 224 can display one or more live camera views while the haptic I/O device 105 is performing the rock crawl function.

Additionally, the rock crawl profile can include a mapped force profile associated with rock crawling control that correlates reliably with vehicle throttle response to provide active feedback to the user. The haptic I/O device 105 can also provide haptic feedback based on one or more factors affecting throttle and wheel speed (e.g., wheel rotation/spin, RPM, etc.). The haptic I/O device 105 can provide counter rotation to provide the active feedback to the user, such as to indicate current terrain conditions and the status of the vehicle 200 as it traverses the terrain. For example, if RPM increases but wheel speed decreases as the vehicle 200 overcomes a large obstacle, the knob 300 can be more difficult to rotate as overcoming this new force would signal to the user that additional RPM may be needed to go over the obstacle, and that the user may need to pull back as soon as they overcome the obstacle to avoid overcompensating. Once the increased resistance is overcome, the knob 300 can return to a state that is easier to turn, thereby reflecting current vehicle dynamics. Thus, the haptic I/O device 105 can provide feedback similar to other driving dynamics such as “steering feel” by providing active feedback to enable the user to receive output information indicating changing terrain conditions and react in a controlled manner.

A suspension tuning function can include a profile similar to the winch control and rock crawl profiles. The haptic I/O device 105 can synchronizes or otherwise communicate with the vehicle 200 suspension system (e.g., an active suspension system) for compression and dampening customization. The user can set their suspension settings using the haptic I/O device 105. For example, As the user rotates the knob 300, the counter rotation the knob 300 outputs to the user increases or decreases as compression or rebound change. When the user releases the knob, all force can be removed (e.g., by cutting power to the mechanical actuator 234) so the knob 300 in the position it was left in. Detents can be overlaid on top of this force feedback to help guide the user through discrete suspension tuning values.

FIG. 5D illustrates a function selection UI displayed on by the graphical indicator 236. The function selection UI can display available functions the haptic I/O device 105 can enable input and/or output for. The function selection UI can enable rotation of the knob 300 to hover over a function and depression of the knob 300 to select the currently hovered over function. The haptic I/O device 105 can indicate a switch to another function via detents and/or other feedback. The UI can rotate the functions so a currently hovered over function is displayed on top (e.g., HVAC control in the illustrated example.

In examples, configuration profiles can be adjusted and/or available depending on vehicle 200, such as a current speed of the vehicle 200. At a higher rate of speed, the vehicle 200 operator may require more focus for driving the vehicle, so profiles can be simplified to provide less input and/or output options, feedback can be increased to ensure the user can detect the feedback, and so on. The profiles can be adjusted based on the vehicle going above or below a speed threshold in certain examples (which may be predetermined and/or user-configurable). In certain examples, when the speed threshold is passed, the haptic I/O device 105 by default operates in action mode (e.g., which may be user selectable) to limit dynamic usage while the user is focused on driving. For example, once the vehicle is above 15 MPH, the haptic I/O device 105 may be configured to restrict usage by assuming a high speed profile, such as a pre-defined profile for a single function (e.g., volume control of the audio system). This high-speed mode can also be coupled with a standby active motion as described above (e.g., buddy tracking, providing directions, compass, etc.), among other examples. Once the vehicle slows below a threshold (which may be the same or a different threshold), or the user confirms they are not the driver (e.g., via the operator interface 224), can the active mode be exited.

### Managing Vehicle Accessories

As described above, accessories 290 can connect to the vehicle 200 for operation. The accessories 290 can connect to various components of the vehicle 200 based on the accessory type and functionality. The accessories can include light systems, winches, plows, sensors, I/O devices, HVAC devices, audio and entertainment devices, and/or the like. The haptic I/O device 105 can identify connected accessories 290, identify profiles associated with the identified accessories, and enable input and output functionality for the accessories 290. In certain examples, the haptic I/O device 105 interfaces with the vehicle 200, such as the vehicle controller 260, to identify the accessories 290, identify the associated profile, and enable the input and output functionality for the accessories 290.

In examples, the haptic I/O device 105 can receive (e.g., be updated/flashed to load different function profiles) different function profiles for the accessories 290. The haptic I/O device 105 and/or other components of the vehicle 200 can store the profiles. In some examples, the accessory 290 provides the profile when connected to the vehicle 200. For example, the accessory 290 may provide such a configuration or a library of configurations, among other examples.

When input and/or output associated with an accessory 290 is the current function, the haptic I/O device 105 can operate according to the profile associated with the accessory 290. For example, a light bar profile may have ten detents and specified end stops for selecting a brightness of the light bar, the haptic I/O device 105 can operate according to the winch control profile as described above, and so on. Different configuration parameters for the profiles associated with the accessories 290 include, but are not limited to, the functionality of the haptic I/O device 105 described herein.

### Tactile Interface Device for Touchscreen Displays

As noted above with respect to FIGS. 1C, 1D, and 2, a tactile input device according to aspects described herein may be coupled with a touchscreen or capacitive panel (e.g., magnetically, via suction, via adhesive, etc.), such that the touchscreen or panel detects input from the tactile input device accordingly. In instances where the tactile input device is removably coupled, an operator may customize where the one or input devices are located or even whether the input device is used at all (e.g., such that the operator may remove the input device accordingly). The touchscreen or capacitive panel can identify the various tactile input devices based on the physical profiles of the devices (e.g., long rectangular profile for a slide, small rectangle for a switch, square for a rotatable knob), based on the type of input the device can provide or arrangement of inputs (e.g., sliding input for a slider, capacitive input for knob rotation, etc.), and/or the like. For example, each tactile input device may have a set of capacitive pads or other type of input capability that indicates a device type so the underlying capacitive input device (e.g., the touchscreen or capacitive panel), the vehicle controller 260, or the like can identify where and what was placed thereon. For example, a knob can include be a round array of input points, thereby indicating that a knob has been placed on the display. As another example, the capacitive pads may be in a line configuration, thereby indicating the tactile input device is a slider. Additionally, the tactile input devices may use wireless or wired communication to provide an indication of operator input to the vehicle and/or to control associated functionality according to aspects described herein.

Once the type of input device is identified, the vehicle controller 260 and/or the like can determine what the respective devices are intended to control, such as volume control for a slider, map control for a knob, and turning on and off headlights for a switch, among other examples. The control of the input devices can be configured by a user in certain examples (e.g., via the operator interface 224).

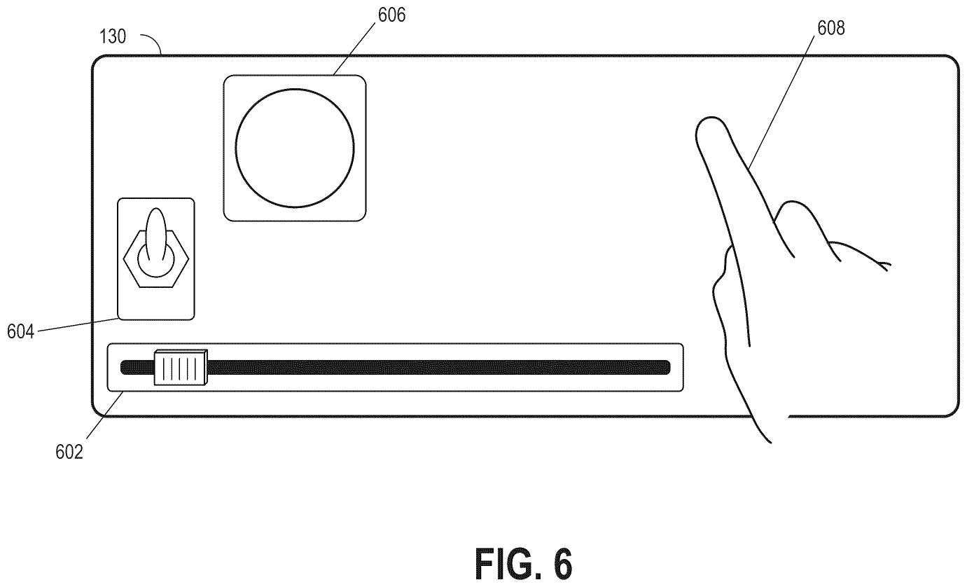

As illustrated in FIG. 6, the second display 130 is coupled with multiple tactile input devices. A slider 602, a switch 604, and a rotatable knob 606 are all coupled to the second display 130. The tactile input devices can all be removably coupled to the second display 130 and arranged in other positions on the second display 130 in further examples. The vehicle controller 260 and/or other components of the vehicle 200 can identify the position and identity of the slider 602, the switch 604, and the rotatable knob 606 based on the device profiles, the capacitive pads or other types of input capabilities and the arrangements of the inputs (e.g., a circle of capacitive pads for the rotatable knob 606, a line of capacitive pads for the slider 602), and/or the like. The vehicle controller 260 and/or other components of the vehicle 200 can then identify the control functionality of the slider 602, the switch 604, and the rotatable knob 606.

When the second display 130 displays a UI, the UI may be adjusted based on the position of the devices, such as the slider 602, the switch 604, and the rotatable knob 606, so the UI is not covered by the devices. For example, the UI can be displayed in the upper right section of the second display 130 where there are no devices or the UI can move elements of the UI where the devices are located so all uncovered space is utilized. Thus, one or more graphical assets may be rearranged so that the graphical elements are still visible around the input device. In some example implementations, the input devices may be permitted to cover some of the display information. The UI may further include feedback corresponding to the input device, for example to indicate what the input device is controlling or an indicator moving to a new position in response to actuation of the input device.

In certain examples, the second display 130 is a touch capable device, so a user input 608 can be utilized for interacting with the second display 130 (e.g., selecting inputs of the UI). The vehicle 200 can identify the user input 608 as separate from the various input devices 602, 604, 606 based on the position of the user input 608, the type (e.g., finger), and/or the like.

As noted above, the tactile input device need not be positioned on a touchscreen and may instead be positioned on a touch-sensitive surface (e.g., a capacitive panel). Additionally, while examples are described with respect to capacitance, it will be appreciated that similar techniques may be used in conjunction with any of a variety of other sensing techniques (e.g., resistive sensing and/or optical sensing). Thus, as an example, a 2″×10″ panel may be hidden behind plastic within a vehicle, such that an operator can attach one or more tactile input devices thereto, which thus function similar as current vehicle switches. Such aspects may provide user configurability.

The removable tactile input devices enable a user to customize the control options of the vehicle 200. These options and configurability can increase the user's ability to accurately control the vehicle 200 in different contexts, such as at high speeds, in difficult terrain, and so on. While touch screens provide various utility for displaying different elements, they lack the tactile feedback that can increase input and output comprehension when a user is focused on another task like driving. Thus, the tactile input devices can increase user control of the vehicle (e.g., adjusting audio volume, changing the suspension settings, turning a device on/off).

### Processes

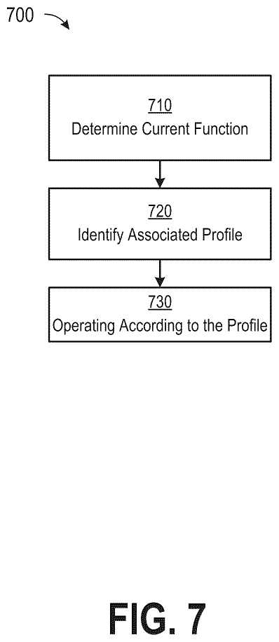

FIG. 7 is a diagram of a process 700 for controlling input and output functionality of the haptic I/O device 105. In operation 710, a current function of the haptic I/O device 105 can be determined. For example, the I/O device controller 238 can determine the current function based on operator input, communicating with the vehicle controller 260, and/or the like. The current function can be a shifter, a drive mode selector, a drive gear selector, a winch controller, a light controller, a navigation controller, an audio system controller, a suspension tuner, an operator interface controller, an agricultural system controller, a recreational vehicle bed controller, a haptic I/O input knob mode selector, a vehicle tracker, a terrain traversal controller, or a plow controller, among further examples.

In operation 720, a profile associated with the current function can be determined. For example, the I/O device controller 238 determines the profile, and the profile can define haptic feedback comprising, detents, end stops, return-to-position forces, active feedback, and so on. In operation 730, the haptic I/O device 105 is caused to operate according to the profile. For example, the I/O device controller 238 controls the components of the haptic I/O device 105 to provide the haptic feedback defined by the profile and control the vehicle 200. In some examples, the process 700 further includes detecting actuation of the knob 300, operating the mechanical actuator 234 provide the haptic feedback, and providing an indication of the actuation to the vehicle 200 (e.g., to the vehicle controller 260) to control the vehicle 200 (e.g., components of the vehicle 200 and/or accessories 290).

In some examples, the current function is a shifter for selecting a transmission gear of the recreational vehicle, and the profile can define a plurality of set positions for selecting each transmission gear option, such as described above and illustrated in FIG. 5A. In example implementations, the haptic feedback includes biasing the knob 300 to settle at one of the plurality of set positions. In some examples, the process 700 further includes detecting actuation of the knob 300 indicating a transmission gear option selection based on the knob 300 settling at one of the plurality of set positions, operating the mechanical actuator 234 to provide the haptic feedback, and providing an indication of the actuation to the vehicle 200 to control the vehicle 200, including setting a transmission of the vehicle 200 to the transmission gear option selection.

In some examples, the process 700 can include determining the haptic I/O device 105 has not been actuated for a period, determining a standby profile of a standby function, and causing the haptic I/O device 105 to operate according to the standby profile. In other examples, the process 700 can include determining a speed of the vehicle 200 is above a speed threshold, determining a high-speed profile of a high-speed function, and causing the haptic I/O device 105 to operate according to the high-speed profile. In further examples, the process 700 includes determining an accessory 290 is connected to the vehicle 200, determining an accessory profile associated with an accessory function to control the accessory 290, determining the current function is the accessory function, and causing the haptic I/O device 105 to operate according to the accessory profile to control the accessory 290.

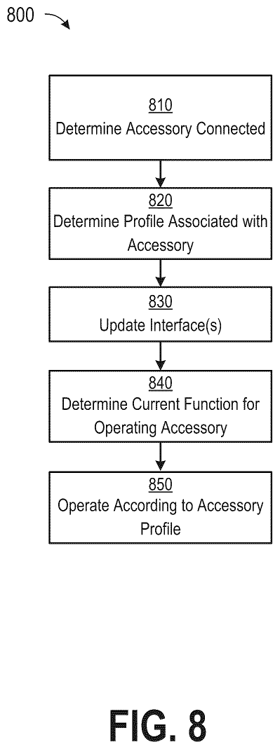

FIG. 8 is a diagram of a process 800 for enabling the haptic I/O device 105 to control functionality of an accessory 290. In operation 810, it is determined that an accessory is connected to a vehicle. For example, the I/O device controller 238 determines an accessory 290 is connected to the vehicle 200. In operation 820, a profile associated with the accessory 290 is determined, such as by the I/O device controller 238.

In operation 830, the interface(s) of the haptic I/O device 105 are updated, such as to enable the haptic I/O device 105 to operate according to the accessory profile. In operation 840, the I/O device controller 238 determines the current function is to operate the accessory 290. In operation 850, the I/O device controller 238 causes the haptic I/O device 105 to operate according to the accessory profile.

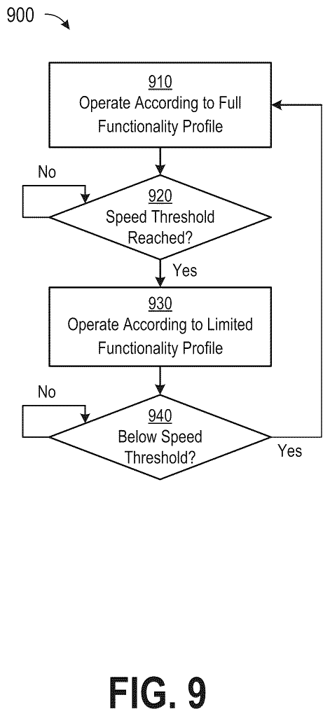

FIG. 9 is a diagram of a process 900 for managing the functionality of the haptic I/O device 105 based on a speed of the recreational vehicle (e.g., the vehicle 200). In operation 910, the haptic I/O device 105 operates according to a full functionality profile, such as profile that is available when the vehicle 200 is below a speed threshold. At decision 920, it is determined, for example by the I/O device controller 238, whether the vehicle 200 reaches a speed threshold. When the vehicle reaches the speed threshold, the process 900 proceeds to operation 930. In operation 930, the I/O device controller 238 causes the haptic I/O device 105 to operate according to a limited functionality profile (e.g., a high-speed profile of a high-speed function). In decision 940, is determined it is determined, for example by the I/O device controller 238, whether the vehicle 200 moves below the speed threshold. When the vehicle 200 moves below the speed threshold, the process 900 can proceed back to operation 910.

Referring to the above processes and processes generally, it is noted that certain aspects may be performed in different orders. Examples of the present invention, for example, are described above with reference to block diagrams and/or operational illustrations of processes, systems, and computer program products according to examples of the invention. The functions/acts noted in the blocks may occur out of the order as shown in any diagram. For example, two blocks shown in succession may in fact be executed substantially concurrently or the blocks may sometimes be executed in the reverse order, depending upon the functionality/acts involved.

The description and illustration of one or more examples provided in this application are not intended to limit or restrict the scope of the invention as claimed in any way. The examples, examples, and details provided in this application are considered sufficient to convey possession and enable others to make and use the best mode of claimed invention. The claimed invention should not be construed as being limited to any example, example, or detail provided in this application. Regardless of whether shown and described in combination or separately, the various features (both structural and methodological) are intended to be selectively included or omitted to produce an example with a particular set of features. Having been provided with the description and illustration of the present application, one skilled in the art may envision variations, modifications, and further examples falling within the spirit of the broader aspects of the general inventive concept embodied in this application that do not depart from the broader scope of the claimed invention.

The examples described herein may be implemented using hardware, software, or a combination thereof and may be implemented in one or more computer systems or other processing systems. However, the manipulations performed by these examples may have been referred to in terms which are commonly associated with mental operations performed by a human operator. No such capability of a human operator is necessary in any of the operations described herein. Rather, the operations may be completely implemented with machine operations. Useful machines for performing the operation of the examples presented herein include general purpose digital computers or similar devices.

Examples of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, examples of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium.

More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. Furthermore, examples of the disclosure may be practiced in an electrical circuit comprising discrete electronic elements, packaged or integrated electronic chips containing logic gates, a circuit utilizing a microprocessor, or on a single chip containing electronic elements or microprocessors. Examples of the disclosure may also be practiced using other technologies capable of performing logical operations such as, for example, AND, OR, and NOT, including but not limited to, mechanical, optical, fluidic, and quantum technologies. In addition, examples of the disclosure may be practiced within a general-purpose computer or in any other circuits or systems.

Examples of the disclosure may be practiced via a system-on-a-chip (SOC) where each or many of the elements described herein (e.g., components of the vehicle 200 including the haptic I/O device 105, and/or the like) may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to examples of the disclosure, may be performed via application-specific logic integrated with other components of the computing device on the single integrated circuit (chip).

From a hardware standpoint, a CPU typically includes one or more components, such as one or more microprocessors, for performing the arithmetic and/or logical operations required for program execution, and storage media, such as one or more memory cards (e.g., flash memory) for program and data storage, and a random-access memory, for temporary data and program instruction storage. From a software standpoint, a CPU typically includes software resident on a storage media (e.g., a memory card), which, when executed, directs the CPU in performing transmission and reception functions. The CPU software may run on an operating system stored on the storage media, such as, for example, UNIX or Windows, iOS, Linux, and the like, and can adhere to various protocols such as the Ethernet, ATM, TCP/IP protocols and/or other connection or connectionless protocols. As is well known in the art, CPUs can run different operating systems, and can contain different types of software, each type devoted to a different function, such as handling and managing data/information from a particular source or transforming data/information from one format into another format. It should thus be clear that the examples described herein are not to be construed as being limited for use with any particular type of server computer, and that any other suitable type of device for facilitating the exchange and storage of information may be employed instead.

A CPU may be a single CPU, or may include plural separate CPUs, wherein each is dedicated to a separate application, such as, for example, a data application, a voice application, and a video application. Software examples of the examples presented herein may be provided as a computer program product, or software, which may include an article of manufacture on a machine accessible or non-transitory computer-readable medium (i.e., also referred to as “machine readable medium”) having instructions. The instructions on the machine accessible or machine-readable medium may be used to program a computer system or other electronic device. The machine-readable medium may include, but is not limited to, optical disks, CD-ROM s, and magneto-optical disks or other type of media/machine readable medium suitable for storing or transmitting electronic instructions. The techniques described herein are not limited to any particular software configuration. They may find applicability in any computing or processing environment. The terms “machine accessible medium”, “machine readable medium” and “computer-readable medium” used herein shall include any non-transitory medium that is capable of storing, encoding, or transmitting a sequence of instructions for execution by the machine (e.g., a CPU or other type of processing device) and that cause the machine to perform any one of the processes described herein. Furthermore, it is common in the art to speak of software, in one form or another (e.g., program, procedure, process, application, module, unit, logic, and so on) as taking an action or causing a result. Such expressions are merely a shorthand way of stating that the execution of the software by a processing system causes the processor to perform an action to produce a result.

While various examples have been described above, it should be understood that they have been presented by way of example, and not limitation. Thus, the present invention should not be limited by any of the above-described examples but should be defined only in accordance with the following claims and their equivalents. The aspects, examples, and details provided in this application are considered sufficient to convey possession and enable others to make and use the best mode of claimed disclosure. Regardless of whether shown and described in combination or separately, the various features (both structural and methodological) are intended to be selectively included or omitted to produce an example with a particular set of features. Having been provided with the description and illustration of the present application, one skilled in the art may envision variations, modifications, and further aspects falling within the spirit of the broader aspects of the general inventive concept embodied in this application that do not depart from the broader scope of the claimed disclosure.

The following are additional clauses relative to the present disclosure, which could be combined and/or otherwise integrated with any of the examples described above or listed in the claims below.

Clause 1. A method, comprising: determining a current function for a haptic input/output (I/O) device to provide functionality for control of a recreational vehicle; determining a profile associated with the current function, wherein the profile defines haptic feedback; and causing the haptic I/O device to operate according to the profile to provide the haptic feedback and control the recreational vehicle.

Clause 2. The method of clause 1, wherein the haptic feedback comprises any one of: (i) one or more detents, (ii) one or more end stops, (iii) one or more return-to-position forces, (iv) active feedback, or (v) any combination of (i)-(iv).

Clause 3. The method of clause 1, wherein causing the haptic I/O device to operate according to the profile comprises: detecting action of an input component of the haptic I/O device; operating a mechanical actuator of the haptic I/O device to provide the haptic feedback; and providing an indication of the actuation to the recreational vehicle to control the recreational vehicle.

Clause 4. The method of clause 3, wherein providing the indication of the actuation to the recreational vehicle comprises providing the indication of the actuation to a vehicle controller of the recreational vehicle.

Clause 5. The method of clause 1, the current function is a shifter for selecting a transmission gear of the recreational vehicle.

Clause 6. The method of clause 5, further comprising: detecting actuation of an input device of the haptic I/O device indicating a transmission gear option selection; operating a mechanical actuator of the haptic I/O device to provide the haptic feedback; and providing an indication of the actuation to the recreational vehicle to control the recreational vehicle, including setting a transmission of the recreational vehicle to the transmission gear option selection.

Clause 7. The method of clause 1, further comprising: determining the haptic I/O device has not been actuated for a period; determining a standby profile of a standby function; and causing the haptic I/O device to operate according to the standby profile.

Clause 8. The method of clause 7, wherein the standby function is vehicle tracking, displaying a compass, displaying navigation directions, waypoint finding, a timer, a clock, an audio system indicator, a power system indicator, or a suspension indicator.

Clause 9. The method of clause 1, further comprising: determining a speed of the recreational vehicle is above a speed threshold; determining a high-speed profile of a high-speed function; and causing the haptic I/O device to operate according to the high-speed profile.

Clause 10. The method of clause 9, further comprising: determining the speed of the recreational vehicle is below the speed threshold; determining a full-functionality profile of full-functionality function; and causing the haptic I/O device to operate according to the full-functionality profile.

Clause 11. The method of clause 1, further comprising: determining an accessory is connected to the vehicle; determining an accessory profile associated with an accessory function to control the accessory; determining the current function is the accessory function; and causing the haptic I/O device to operate according to the accessory profile to control the accessory.

Clause 12. The method of clause 1, further comprising providing the indication of the received information after actuation has not been detected for a predetermined amount of time.

Clause 13. A haptic input/output (I/O) device for a recreational vehicle, the haptic I/O device comprising: an I/O device controller configured to: determine a current function for a haptic I/O device to provide functionality for control of a recreational vehicle; determine a profile associated with the current function, wherein the profile defines haptic feedback; and cause the haptic I/O device to operate according to the profile to provide the haptic feedback and control the recreational vehicle.

Clause 14. The haptic input/output (I/O) device of clause 13, wherein the I/O device controller is configured to perform the method of any of clauses 2-12.

Clause 15. A vehicle, comprising: a touch-sensitive input device configured to removably couple with a tactile input device; and a controller communicatively coupled to the touch-sensitive input device, the controller configured to: detect, via the touch-sensitive input device, a set of capacitive pads associated with a tactile input device, wherein a first portion of the set of capacitive pads indicates a type associated with the tactile input device and a second portion of the set of capacitive pads is configured to indicate user actuation of the tactile input device; identify, via the second portion of the set of capacitive pads, actuation of the tactile input device; and control functionality of the vehicle according to the identified actuation.

Clause 16. The vehicle of clause 15, wherein the touch-sensitive input device comprises a touchscreen display and the touchscreen display is configured to magnetically couple with the tactile input device.

Clause 17. The vehicle of clause 16, wherein the controller is further configured to adapt a user interface of the vehicle in response to detecting the set of capacitive pads according to the type indicated by the first portion of the set of capacitive pads.

Clause 18. A vehicle, comprising: an input device configured to removably couple with a tactile input device; and a controller communicatively coupled to the input device, the controller configured to: determine a type of the tactile input device; determine a component of the vehicle the tactile input device is intended to control; and controlling the component of the vehicle based on input received by the tactile input device.

Clause 19. The vehicle of clause 18, wherein the controller is configured to determine the type of the tactile input device based on any one of (i) a physical profile, (ii) an arrangement of inputs of the tactile input device, or (iii) both (i) and (ii).

Clause 20. The vehicle of clause 18, wherein the controller is configured to determine the type of the tactile input device based on an arrangement of capacitive pads of the tactile input device.

Clause 21. The vehicle of clause 18, wherein the input device is configured to display a user interface.

Clause 22. The vehicle of clause 21, wherein the input device is configured to display the interface around the tactile input device so the user interface is not covered.

Clause 23. The vehicle of clause 18, wherein the input device is configured to receive input at portions of the input device not covered by the tactile input device.

Clause 24. The vehicle of clause 18, wherein the tactile is a switch, a slider, or a rotatable knob.

Clause 25. The vehicle of clause 18, wherein the input device is a touch-sensitive surface.

Clause 26. A method, comprising: determining a current function for a haptic input/output (I/O) device to provide functionality for control of a recreational vehicle, wherein the current function is a shifter for selecting a transmission gear of the recreational vehicle; determining a profile associated with the current function, wherein the profile defines haptic feedback comprising a plurality of set positions for selecting each transmission gear option; and causing the haptic I/O device to operate according to the profile to provide the haptic feedback and control the recreational vehicle, including setting a transmission of the recreational vehicle to the transmission gear option selection.

Clause 27. A vehicle, comprising: a haptic I/O device with configurable feedback parameters; and a vehicle controller configured to: receive an indication of input from the haptic I/O device; and control the vehicle based on the indication of input.

Clause 28. The vehicle of clause 27, wherein the vehicle controller is further configured to: detect connection of an accessory; receive accessory configuration parameters; and automatically configure the haptic I/O device based on the accessory configuration parameters.

Clause 29. A method comprising: detecting a technology-enabled accessory connected to a vehicle; identifying accessory-specific haptic configuration parameters including: detent characteristics, end stop positions, return-to-position behavior, and/or output configurations; automatically configuring a haptic I/O device according to the identified parameters; and storing the configuration for subsequent accessory recognition.

Clause 30. A haptic control system comprising: a knob with motor-driven feedback, one or more sensors for monitoring vehicle operational parameters, a controller configured to: receive real-time vehicle operational data, dynamically adjust haptic feedback force based on the operational data, and overlay feedback profiles on existing haptic configurations.

Clause 31. A vehicle comprising: a haptic I/O device for throttle control; sensors for monitoring: wheel rotation/spin, engine RPM, and/or vehicle speed; and a controller configured to cause the haptic I/O device to provide haptic feedback based on the monitoring by the sensors.

Clause 32. The vehicle of clause 31, wherein the controller is further configured to: generate mapped force profiles based on terrain conditions, adjust feedback resistance proportional to detected obstacles, and modify end stop positions based on operating mode.

Clause 33. A vehicle comprising: a haptic I/O device configured to provide dynamic feedback; a speed sensor configured to monitor a speed of the vehicle; and a controller configured to: monitor the vehicle speed using the speed sensor; automatically switch between multiple haptic feedback modes based on speed, restrict available functions above speed thresholds, and/or provide standby information display functionality.

Clause 34. A haptic input/output (I/O) device for a recreational vehicle, the haptic I/O device comprising: an I/O device controller configured to: detect actuation of an input device of the haptic I/O device indicating a transmission gear option selection; operate a mechanical actuator of the haptic I/O device to provide the haptic feedback; and provide an indication of the actuation to the recreational vehicle to control the recreational vehicle, including setting a transmission of the recreational vehicle to the transmission gear option selection.

What is claimed is:

1. A method, comprising:
determining a current function for a haptic input/output (I/O) device to provide functionality for control of a recreational vehicle;
determining a profile associated with the current function, wherein the profile defines haptic feedback comprising any one of: (i) one or more detents, (ii) one or more end stops, (iii) one or more return-to-position forces, or (iv) any combination of (i)-(iii); and
causing the haptic I/O device to operate according to the profile to provide the haptic feedback and control the recreational vehicle.

2. The method of claim 1, wherein causing the haptic I/O device to operate according to the profile comprises:
detecting actuation of a knob of the haptic I/O device;
operating a mechanical actuator of the haptic I/O device to provide the haptic feedback; and
providing an indication of the actuation to the recreational vehicle to control the recreational vehicle.

3. The method of claim 2, wherein providing the indication of the actuation to the recreational vehicle comprises providing the indication of the actuation to a vehicle controller of the recreational vehicle.

4. The method of claim 1, wherein:
the current function is a shifter for selecting a transmission gear of the recreational vehicle; and
the profile defines a plurality of set positions for selecting each transmission gear option.

5. The method of claim 4, wherein the haptic feedback comprises biasing a knob of the haptic I/O device to settle at one of the plurality of set positions.

6. The method of claim 4, further comprising:
detecting actuation of a knob of the haptic I/O device indicating a transmission gear option selection based on the knob settling at one of the plurality of set positions;
operating a mechanical actuator of the haptic I/O device to provide the haptic feedback; and
providing an indication of the actuation to the recreational vehicle to control the recreational vehicle, including setting a transmission of the recreational vehicle to the transmission gear option selection.

7. The method of claim 1, wherein the current function is any one of: (i) a shifter, (ii) a drive mode selector, (iii) a drive gear selector, (iv) a winch controller, (v) a light controller, (vi) a navigation controller, (vii) an audio system controller, (viii) a suspension tuner, (ix) an operator interface controller, (x) an agricultural system controller, (xi) a recreational vehicle bed controller, (xii) a haptic I/O input knob mode selector, (xiii) a vehicle tracker, (xiv) a terrain traversal controller, or (xv) a plow controller.

8. The method of claim 1, wherein the profile further defines the haptic feedback as comprising active feedback.

9. The method of claim 1, further comprising:
determining the haptic I/O device has not been actuated for a period;
determining a standby profile of a standby function; and
causing the haptic I/O device to operate according to the standby profile.

10. The method of claim 1, further comprising:
determining a speed of the recreational vehicle is above a speed threshold;
determining a high-speed profile of a high-speed function; and
causing the haptic I/O device to operate according to the high-speed profile.

11. The method of claim 1, further comprising:
determining an accessory is connected to the vehicle;
determining an accessory profile associated with an accessory function to control the accessory;
determining the current function is the accessory function; and
causing the haptic I/O device to operate according to the accessory profile to control the accessory.

12. A haptic input/output (I/O) device for a recreational vehicle, the haptic I/O device comprising:
a knob configured to receive input and provide output via rotation;
a position sensor configured to identify a rotational position of the knob;
a mechanical actuator configured to actuate the knob; and
an I/O device controller, configured to:
determine a current function for the haptic I/O device to provide functionality for control of the recreational vehicle;
determine a profile associated with the current function, wherein the profile defines haptic feedback comprising any one of: (i) one or more detents, (ii) one or more end stops, (iii) one or more return-to-position forces, or (iv) any combination of (i)-(iii); and
cause the haptic I/O device to operate according to the profile to provide the haptic feedback and control the recreational vehicle.

13. The haptic I/O device of claim 12, wherein to cause the haptic I/O device to operate according to the profile comprises the I/O device controller to:
detect, using the position sensor, actuation of the knob;
operate the mechanical actuator according to an operating mode to provide the haptic feedback; and
provide an indication of the detected actuation to the recreational vehicle to control the recreational vehicle.

14. The haptic I/O device of claim 13, wherein to provide the indication of the actuation to the recreational vehicle comprises to provide the indication of the actuation to a vehicle controller of the recreational vehicle.

15. The haptic I/O device of claim 12, wherein:
the current function is a shifter for selecting a transmission gear of the recreational vehicle; and
the profile defines a plurality of set positions for selecting each transmission gear option.

16. The haptic I/O device of claim 15, wherein the haptic feedback comprises the mechanical actuator biasing the knob of the haptic I/O device to settle at one of the plurality of set positions.

17. The haptic I/O device of claim 15, wherein the I/O device controller is further configured to:
detect, using the position sensor, actuation of the knob indicating a transmission gear option selection based on the knob settling at one of the plurality of set positions;
operate the mechanical actuator to provide the haptic feedback; and
provide an indication of the actuation to the recreational vehicle to control the recreational vehicle, including setting a transmission of the recreational vehicle to the transmission gear option selection.

18. The haptic I/O device of claim 12, wherein the profile further defines the haptic feedback as comprising active feedback.

19. The haptic I/O device of claim 12, wherein the I/O device controller is further configured to:
determine the haptic I/O device has not been actuated for a period;
determine a standby profile of a standby function; and
cause the haptic I/O device to operate according to the standby profile.

20. The haptic I/O device of claim 12, wherein the I/O device controller is further configured to:
determine a speed of the recreational vehicle is above a speed threshold;
determine a high-speed profile of a high-speed function; and
cause the haptic I/O device to operate according to the high-speed profile.

21. The haptic I/O device of claim 12, wherein the I/O device controller is further configured to:
determine an accessory is connected to the vehicle;
determine an accessory profile associated with an accessory function to control the accessory;
determine the current function is the accessory function; and
cause the haptic I/O device to operate according to the accessory profile to control the accessory.

22. The haptic I/O device of claim 12, wherein the I/O device controller is further configured to:
receive information associated with the recreational vehicle from a vehicle controller of the recreational vehicle; and
operate the mechanical actuator to provide an indication of the received information.

23. The haptic I/O device of claim 12, wherein:
the haptic I/O device further comprises a magnet;
the position sensor is a magnetic encoder configured to detect rotation of the magnet; and
the mechanical actuator is a brushless direct current motor.

24. The haptic I/O device of claim 12, further comprising a directional light system configured to provide output according to the profile.

25. The haptic I/O device of claim 12, further comprising an enclosure with one or more environmental seals configured to provide ingress protection for the position sensor and the mechanical actuator.

26. The haptic I/O device of claim 12, further comprising a tactile dome positioned to be depressed by the knob when the knob receives axial force.

27. A vehicle, comprising:
a vehicle controller; and
a haptic I/O device comprising:
a knob configured to receive input and provide output via rotation;
a position sensor configured to identify a rotational position of the knob;
a mechanical actuator configured to actuate the knob; and
an I/O device controller, configured to:
determine a current function for a haptic input/output (I/O) device to provide functionality for control of a recreational vehicle;
determine a profile associated with the current function, wherein the profile defines haptic feedback comprising any one of: (i) one or more detents, (ii) one or more end stops, (iii) one or more return-to-position forces, or (iv) any combination of (i)-(iii); and
cause the haptic I/O device to operate according to the profile to provide the haptic feedback and control the recreational vehicle.
